(19) United States
(12) Patent Application Publication
(10) Pub. No.: US 2020/0310114 A1
(43) Pub. Date: Oct. 1, 2020

(54) DISPLAY DEVICE, DISPLAY SYSTEM, AND MOBILE OBJECT

(71) Applicant: Hiroyuki TANABE, Tokyo (JP)

(72) Inventor: Hiroyuki TANABE, Tokyo (JP)

(21) Appl. No.: 16/770,737

(22) PCT Filed: Mar. 6, 2019
(86) PCT No.: PCT/JP2019/008947

§ 371 Date: Jun. 8, 2020

(30) Foreign Application Priority Data
Mar. 19, 2018 (JP) 2018-050972

(51) Int. Cl. G02B 27/01; G02B 3/00; G02B 26/10; G02B 26/08; B60K 35/00

(52) U.S. Cl. CPC G02B 27/0101; G02B 3/0056; G02B 26/101; B60K 2370/1529; G02B 26/0833; B60K 35/00; G02B 2003/0093; G02B 3/0043

(57) ABSTRACT

A display device is provided with an optical element including a plurality of microlenses arranged in an array, through which light diverges, and a scanner configured to scan the optical element two-dimensionally using light emitted from a light source. A longer axis direction of a visually-recognizable area, where a virtual image formed by diverging light that diverges as passing through the plurality of microlenses can visually be recognized as a prescribed image, matches a longer axis direction of the plurality of microlenses.

### TECHNICAL FIELD

Embodiments of the present disclosure relate to a display device, a display system, and a mobile object.

### BACKGROUND ART

Display devices such as a heads-up display (HUD) are used as an application in a mobile object such as a vehicle that allows a driver (viewer) to recognize various kinds of information (for example, vehicle information, navigation information, and warning information) with a reduced amount of movement in line of vision.

Moreover, display devices are known in the art that form an intermediate image by optically scanning a microlens array used as an optical element. In such display devices,

the shape of microlenses and the shape of incident light are appropriately controlled such that the interfering noise that is caused by highly coherent laser beams will be reduced.

For example, PTL 1 discloses that a plurality of microlenses of the microlens array are vertically oriented in a laser scanning HUD using an optical element such as a microlens.

### CITATION LIST

### Patent Literature

PTL 1: Japanese Patent Application Publication No. 2014-139657

### SUMMARY OF INVENTION

### Technical Problem

However, in the above-described method, the range in which an observer can visually recognize an image is vertically oriented when it is assumed that the curvature of a plurality of microlenses that together configure an optical element such as a microlens array is constant in the X-direction and the Y-direction (in both vertical and horizontal directions). For this reason, when a display device is provided for a mobile object such as a vehicle, the visually-recognizable area in the vertical direction needs to be expanded to secure the visually-recognizable area in the lateral direction where the viewpoint of the driver (observer) can easily be moved, and the brightness of the image that is to be visually recognized by the viewer deteriorates.

### Solution to Problem

A display device is provided with an optical element including a plurality of microlenses arranged in an array, through which light diverges, and a scanner configured to scan the optical element two-dimensionally using light emitted from a light source. A longer axis direction of a visually-recognizable area, where a virtual image formed by diverging light that diverges as passing through the plurality of microlenses can visually be recognized as a prescribed image, matches a longer axis direction of the plurality of microlenses.

### Advantageous Effects of Invention

According to one aspect of the present disclosure, reduction in the brightness of an image to be visually recognized by a viewer can efficiently be controlled.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating a system configuration of a display system according to an embodiment of the present disclosure.

FIG. 2 is a diagram illustrating a hardware configuration of a display device according to an embodiment of the present disclosure.

FIG. 3 is a diagram illustrating a functional configuration of a display device according to an embodiment of the present disclosure.

FIG. 4 is a diagram illustrating a specific configuration of a light-source device according to an embodiment of the present disclosure.

FIG. 5 is a diagram illustrating a specific configuration of a light deflector according to an embodiment of the present disclosure.

FIG. 6 is a diagram illustrating a specific configuration of a screen according to an embodiment of the present disclosure.

FIG. 7A and FIG. 7B are diagrams illustrating a difference in operation due to differences in sizes of the diameter of incident light flux and the lens diameter in a microlens array, according to an embodiment of the present disclosure.

FIG. 8 is a diagram illustrating the relation between a mirror of a light deflector and the scanning range, according to an embodiment of the present disclosure.

FIG. 9 is a diagram illustrating the trajectory of a scanning line when two-dimensional scanning is performed, according to an embodiment of the present disclosure.

FIG. 10 is a diagram illustrating the plotted dots on a microlens array, according to an embodiment of the present disclosure.

FIG. 11 is a diagram illustrating the relation between the incident position of light flux on a microlens and the intensity of dot images on that microlens, according to an embodiment of the present disclosure.

FIG. 12 is a diagram illustrating the distribution of the intensity of dot images on a microlens array when a light-source device is continuously turned on with a constant output, according to an embodiment of the present disclosure.

FIG. 13 is a diagram illustrating the distribution of the intensity of dot images on a microlens array when a high-power mode and a low-power mode are performed while multiple microlenses are being scanned, according to an embodiment of the present disclosure.

FIG. 14 is a diagram illustrating the distribution of the intensity of dot images on a microlens array when thinned-out lighting is performed, according to an embodiment of the present disclosure.

FIG. 15A to FIG. 15F are diagrams each illustrating a concrete example of an output pattern, according to an embodiment of the present disclosure.

FIG. 16 is a diagram illustrating the relation among the intervals at which thinning-out is performed, the intervals at which lenses are arranged, and moire, according to an embodiment of the present disclosure.

FIG. 17 is a schematic diagram illustrating the relative positions of the elements in a display system according to an embodiment of the present disclosure.

FIG. 18 is a diagram illustrating the relation between a microlens array and an eye box, according to an embodiment of the present disclosure.

FIG. 19 is a diagram illustrating the relation between an intermediate image and an virtual image, according to an embodiment of the present disclosure.

FIG. 20A and FIG. 20B are schematic diagrams each illustrating the relation between the shape of microlenses and the shape of an eye box, according to a control sample.

FIG. 21 is a diagram illustrating the relation between the shape of microlenses and the shape of an eye box, according to an embodiment of the present disclosure.

FIG. 22A, FIG. 22B, and FIG. 22C are diagrams each illustrating the arrangement of microlenses in a microlens array, according to an embodiment of the present disclosure.

FIG. 23 is a diagram illustrating the vertices of a plurality of microlenses in a random lens array, according to the present embodiment.

FIG. 24A, FIG. 24B, and FIG. 24C are diagrams each illustrating a concrete example of a horizontally-oriented random lens array, according to an embodiment of the present disclosure.

FIG. 25A to FIG. 25C are diagrams each illustrating the vertex of a microlens according to a control sample. FIG. 25D to FIG. 25F are diagrams each illustrating the vertex of a horizontally-oriented microlens, according to an embodiment of the present disclosure.

FIG. 26 is a diagram illustrating a structure of a microlens array according to an embodiment of the present disclosure.

### DESCRIPTION OF EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Embodiments of the present disclosure are described below with reference to the accompanying drawings. In the description of the drawings, like reference signs denote like elements, and overlapping descriptions are omitted.

### Embodiments

System Configuration

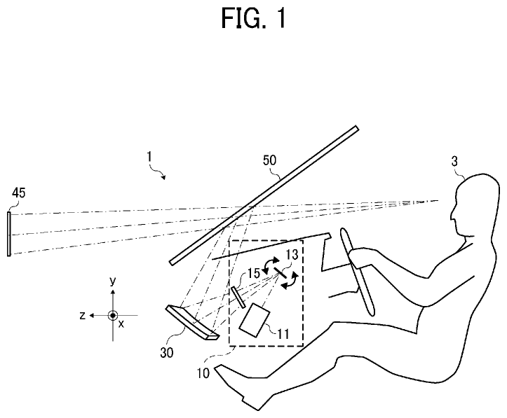

FIG. 1 is a diagram illustrating a system configuration of a display system according to an embodiment of the present disclosure. The display system 1 as illustrated in FIG. 1 can prevent the brightness of a display image from decreasing without reducing the resolution of the display image that is visually recognized by a viewer 3.

In the display system 1, the viewer 3 can visually identify a display image as the projection light that is projected from a display device 10 is projected onto a transmissive reflector. The display image is an image superimposed on the viewing field of the viewer 3 as the virtual image 45. For example, the display system 1 is provided for a mobile object such as a vehicle, an aircraft, and a ship, or an immobile object such as a maneuvering simulation system, and a home-theater system. In the present embodiment, cases in which the display system 1 is provided for a vehicle as an example of the mobile object is described. However, no limitation is intended thereby, and the type of usage of the display system 1 is not limited to the present embodiment.

For example, the display system 1 is mounted in a vehicle, and makes navigation information visible to the viewer 3 (i.e., the driver) through a front windshield 50 of the vehicle. The navigation information includes, for example, the information about the speed of the vehicle, the course information, the distance to a destination, the name of the current place, the presence or position of an object ahead of the vehicle, a traffic sign indicating, for example, speed limit, and traffic congestion, and aids the driving of the vehicle. In such cases, the front windshield 50 serves as a transmissive reflector that transmits a portion of the incident light and reflects at least some of the remaining incident light. The distance between the location of the eyepoint of the viewer 3 and the front windshield 50 is about several tens of centimeters (cm) to one meter (m).

The display system 1 includes a display device 10, a free-form surface mirror 30, and a front windshield 50. For example, the display device 10, is a heads-up display (HUD) provided for a vehicle as an example of the mobile object. The display device 10 may be arranged at any desired position in conformity with the interior design of the vehicle. For example, the display device 10 according to the present embodiment may be disposed under the dashboard of the vehicle or built into the dashboard of the vehicle.

The display device 10 is provided with a light-source device 11, a light deflector 13, and a screen 15. The light-source device 11 is a device that emits the laser beams emitted from a light source outside the device. For example, the light-source device 11 may emit laser beams in which three-color laser beams of red, green, and blue (RGB) are combined. The laser beams emitted from the light-source device 11 are guided to the reflection plane of the light deflector 13. For example, the light-source device 11 has a semiconductor light-emitting element such as a laser diode (LD) that serves as a light source. However, no limitation is intended thereby, and the light source may be a semiconductor light-emitting element such as a light-emitting diode (LED).

The light deflector 13 is a device that uses, for example, the micro-electromechanical systems (MEMS) to change the directions of travel of the laser beams. The light deflector 13 is configured by a scanner such as a mirror system composed of one minute MEMS mirror that pivots around two axes orthogonal to each other or two MEMS mirrors that pivot or rotates around one axis. The laser beams emitted from the light deflector 13 scans the screen 15. The light deflector 13 is not limited to a MEMS mirror, but may be configured by a polygon mirror or the like.

The screen 15 serves as a divergent part that diverges the laser beams at a predetermined divergence angle. For example, the screen 15 may consist of an exit pupil expander (EPE), and may be configured by a transmissive optical element such as a microlens array (MLA) or diffuser panel that diffuses light. Alternatively, the screen 15 may be configured by a reflective optical element such as a micromirror array that diffuses light. The screen 15 forms a two-dimensional intermediate image 40 on the screen 15 as the laser beams emitted from the light deflector 13 scan the surface of the screen 15.

A method of projecting an image using the display device 10 may be implemented by a panel system or a laser scanning system. In the panel system, the intermediate image 40 is formed by an imaging device such as a liquid crystal panel, a digital micromirror device (DMD) panel (digital mirror device panel), or a vacuum fluorescent display (VFD). In the laser scanning system, the intermediate image 40 is formed by scanning the laser beams emitted from the light-source device 11, using an optical scanner.

The display device 10 according to the present embodiment adopts the laser scanning system. In the laser scanning system, each pixel can be assigned to either an emitting pixel or a non-emitting pixel. Accordingly, in the laser scanning system, a high-contrast image can be formed in most cases. In some alternative embodiments, the above-described panel system may be adopted as the projection system in the display device 10.

The virtual image 45 is projected onto the free-form surface mirror 30 and the front windshield 50 as the intermediate image 40 that is formed by the laser beams (bundle of laser beams) emitted from the screen 15 is magnified for view. The free-form surface minor 30 is designed and arranged so as to cancel, for example, the inclination of the image, the distortion of the image, and the displacements of the image, which are caused by the bent shape of the front windshield 50. The free-form surface minor 30 may be arranged in a pivotable manner around the rotation axis. Due to such a configuration, the free-form surface minor 30 can adjust the reflection direction of the laser beams (bundle of laser beams) emitted from the screen 15 to change the position at which the virtual image 45 is displayed.

In the present embodiment, the free-form surface mirror 30 is designed using a commercially available optical design simulation software such that the free-form surface mirror 30 has a certain level of light-gathering power to achieve a desired image-forming position of the virtual image 45. In the display device 10, the light-gathering power of the free-form surface mirror 30 is designed such that the virtual image 45 is displayed at a position away from the location of the eyepoint of the viewer 3 in the depth direction by, for example, at least 1 m and equal to or shorter than 30 m (preferably, equal to or shorter than 10 m). The free-form surface minor 30 may be a concave mirror or an element with a light-gathering power. The free-form surface mirror 30 is an example of an image forming optical system.

The front windshield 50 serves as a transmissive reflector that transmits some of the laser beams (bundle of laser beams) and reflects at least some of the remaining laser beams (partial reflection). The front windshield 50 may serve as a semitransparent mirror through which the viewer 3 visually recognizes the virtual image 45 and the scenery ahead of the mobile object (vehicle). The virtual image 45 is an image that is visually recognized by the viewer 3, including vehicle-related information (e.g., speed and travel distance), navigation information (e.g., route guidance and traffic information), and warning information (e.g., collision warning). For example, the transmissive reflector may be another front windshield arranged in addition to the front windshield 50. The front windshield 50 is an example of a reflector.

The virtual image 45 may be displayed so as to be superimposed on the scenery ahead of the front windshield 50. The front windshield 50 is not flat but is curved. For this reason, the position at which the virtual image 45 is formed is determined by the curved surface of the free-form surface minor 30 and the front windshield 50. In some embodiments, the front windshield 50 may be a semitransparent minor (combiner) that serves as a separate transmissive having a reflector partial reflection function.

Due to such a configuration as above, the laser beams (bundle of laser beams) emitted from the screen 15 is projected towards the free-form surface mirror 30, and is reflected by the front windshield 50. Accordingly, the viewer 3 can visually recognize the virtual image 45, i.e., the magnified image of the intermediate image 40 formed on the screen 15, due to the light reflected by the front windshield 50.

Hardware Configuration

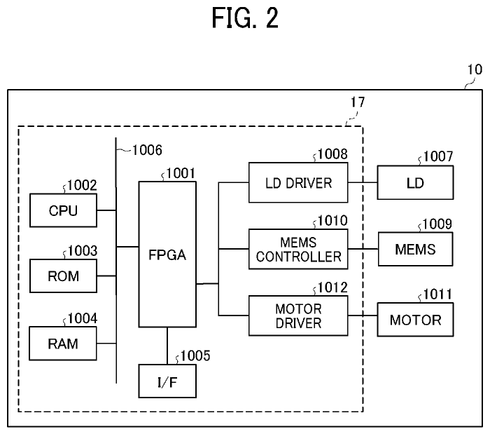

FIG. 2 is a diagram illustrating a hardware configuration of the display device 10 according to the present embodiment. When necessary, some components or elements may be added to or deleted from the hardware configuration illustrated in FIG. 2.

The display device 10 includes a controller 17 that controls the operation of the display device 10. For example, the controller 17 is a circuit board or integrated circuit (IC) chip mounted inside the display device 10. The controller 17 includes a field-programmable gate array (FPGA) 1001, a central processing unit (CPU) 1002, a read only memory (ROM) 1003, a random access memory (RAM) 1004, an interface (I/F) 1005, a data bus line 1006, a laser diode (LD) driver 1008, a micro-electromechanical systems (MEMS) controller 1010, and a motor driver 1012.

The FPGA 1001 is an integrated circuit that is configurable by the designer of the display device 10. The LD driver 1008, the MEMS controller 1010, and the motor driver 1012 generate a driving signal according to the control signal output from the FPGA 1001.

The CPU 1002 is an integrated circuit that controls the entirety of the display device 10. The ROM 1003 is a storage device that stores a program for controlling the CPU 1002. The RAM 1004 is a storage device that serves as a work area of the CPU 1002. The interface 1005 communicates with an external device. For example, the interface 1005 is coupled to the controller area network (CAN) of a vehicle.

For example, the LD 1007 is a semiconductor light-emitting element that configures a part of the light-source device 11. The LD driver 1008 is a circuit that generates a driving signal for driving the LD 1007. The MEMS 1009 configures a part of the light deflector 13 and moves the scanning minor. The MEMS controller 1010 is a circuit that generates a driving signal for driving the MEMS 1009. A motor 1011 is an electric motor that rotates the rotation axis of the free-form surface minor 30. The motor driver 1012 is a circuit that generates a driving signal for driving the motor 1011.

Functional Configuration

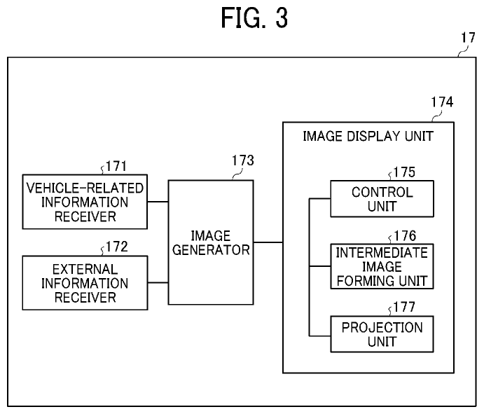

FIG. 3 is a diagram illustrating a functional configuration of the display device 10 according to the present embodiment. The functions that are implemented by the display device 10 include a vehicle-related information receiver 171, an external information receiver 172, an image generator 173, and an image display unit 174.

The vehicle-related information receiver 171 is a function to receive vehicle-related information (e.g., speed and travel distance) from a controller area network (CAN) or the like. For example, the vehicle-related information receiver 171 is implemented by some of the elements illustrated in FIG. 2. In particular, the vehicle-related information receiver 171 may be implemented by the interface 1005, the processing performed by the CPU 1002, and a program stored in the ROM 1003.

The external information receiver 172 receives external information (for example, position information from the global positioning system (GPS), routing information from a navigation system, and traffic information) of the vehicle from an external network. For example, the external information receiver 172 is implemented by some of the elements illustrated in FIG. 2. In particular, the external information receiver 172 may be implemented by the interface 1005, the processing performed by the CPU 1002, and a program stored in the ROM 1003.

The image generator 173 is a function to generate image data, which is used to display the intermediate image 40 and the virtual image 45, based on the data input from the vehicle-related information receiver 171 and the external information receiver 172. For example, the image generator 173 is implemented by some of the elements illustrated in FIG. 2. In particular, the image generator 173 may be implemented by the processing performed by the CPU 1002, and a program stored in the ROM 1003.

The image display unit 174 is a function to form the intermediate image 40 on the screen 15 based on the image data generated by the image generator 173, and to project the laser beams (bundle of laser beams) that form the intermediate image 40 towards the front windshield 50 to display the virtual image 45. For example, the image display unit 174 is implemented by some of the elements illustrated in FIG. 2. In particular, the image display unit 174 may be implemented by the processing performed by the CPU 1002, the FPGA 1001, the LD driver 1008, the MEMS controller 1010, and the motor driver 1012, as well as a program stored in the ROM 1003.

The image display unit 174 includes a control unit 175, an intermediate image forming unit 176, and a projection unit 177. In order to form the intermediate image 40, the control unit 175 generates a control signal used to control the operation of the light-source device 11 and the light deflector 13. Moreover, the control unit 175 generates a control signal that controls the operation of the free-form surface mirror 30 to display the virtual image 45 at a desired position.

The intermediate image forming unit 176 forms the intermediate image 40 on the screen 15 based on the control signal generated by the control unit 175. The projection unit 177 projects the laser beams that form the intermediate image 40 towards the transmissive reflector (e.g., the front windshield 50) in order to form the virtual image 45 to be visually recognized by the viewer 3.

Light-Source Device

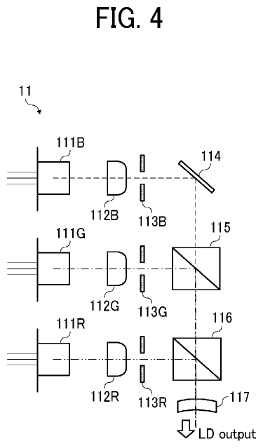

FIG. 4 is a diagram illustrating a specific configuration of the light-source device 11 according to the present embodiment. The light-source device 11 includes light-source elements 111R, 111G, and 111B (these light-source elements may be referred to simply as a light-source element 111 in the following description when it is not necessary to distinguish each of the light-source elements), coupling lenses 112R, 112G, and 112B, apertures 113R, 113G, and 113B, combiners 114, 115, and 116, and a lens 117. The light-source device 11 is an example of a light source.

For example, each of the light-source elements 111 R, 111 G, and 111B of three colors (R, G, B) of three colors (red, green, and blue (RGB)) is a laser diode (LD) having a single or a plurality of light-emitting points. The light-source elements 111R, 111G, and 111B emit bundles of laser beams (light flux) having different wavelengths λR, λG, and λB, respectively. For example, λR=640 nanometers (nm), λG=530 nm, and λB=445 nm.

The emitted bundles of laser beams (light flux) are coupled by the coupling lenses 112R, 112G, and 112B, respectively. The coupled bundles of laser beams (light flux) are shaped by the apertures 113R, 113G, and 113B, respectively. The shape of the apertures 113R, 113G, and 113B may be various kinds of shape such as a circle, an ellipse, a rectangle, and a square depending on, for example, certain predetermined conditions such as the divergence angle of the bundles of laser beams (light flux).

The multiple laser beams (light flux) that are shaped by the apertures 113R, 113G, and 113B are combined by the three combiners 114, 115, and 116, respectively. The combiners 114, 115, and 116 are plate-like or prismatic dichroic mirrors, and reflect or transmit the laser beams (light flux) therethrough according to the wavelength of the laser beams to combine the laser beams into one bundle of laser beams (light flux) that travels along one optical path. The combined bundle of laser beams passes through the lens 117 and is guided to the light deflector 13.

Light Deflector

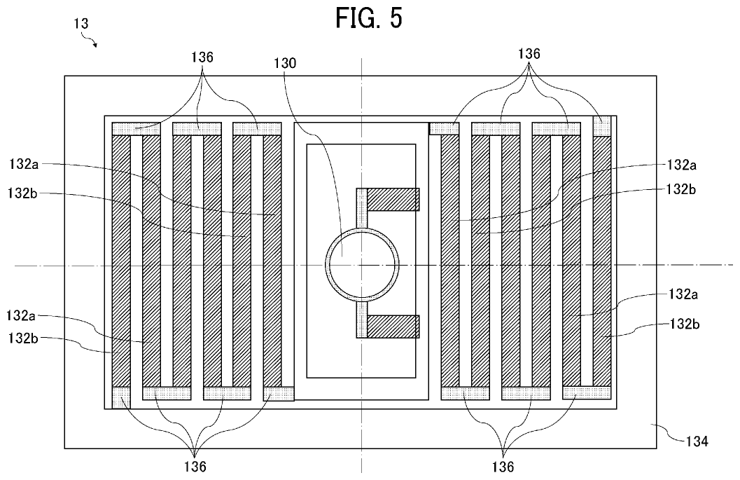

FIG. 5 is a diagram illustrating a specific configuration of the light deflector 13 according to the present embodiment. The light deflector 13 is a MEMS mirror produced by semiconductor processing, and includes a mirror 130, a serpentine beam 132, a frame 134, and a piezoelectric member 136. The light deflector 13 is an example of a scanner.

The minor 130 has a reflection plane that reflects the laser beams emitted from the light-source device 11 towards the screen 15 side. In the light deflector 13, a pair of serpentine beams 132 are formed across the mirror 130. Each of the pair of serpentine beams 132 has a plurality of turning portions. Each of these turning portions is configured by a first beam 132a and a second beam 132b that are arranged alternately. Each of the pair of serpentine beams 132 is supported by the frame 134. The piezoelectric member 136 is disposed such that the first beam 132a and the second beam 132b, which are adjacent to each other, are coupled to each other. The piezoelectric member 136 applies different levels of voltage to the first beam 132a and the second beam 132b to bend each of the first beam 132a and the second beam 132b differently.

As a result, the first beam 132a and the second beam 132b, which are adjacent to each other, bend in different directions. As the bending force is accumulated, the mirror 130 rotates in the vertical direction around the horizontal axis. Due to such a configuration as above, the light deflector 13 can perform optical scanning in the vertical direction at a low voltage. An optical scanning in the horizontal direction around the axis in the vertical direction is implemented by the resonance produced by a torsion bar or the like coupled to the mirror 130.

Screen

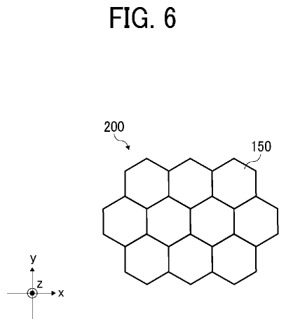

FIG. 6 is a diagram illustrating a specific configuration of the screen 15 according to the present embodiment. The laser beams emitted from the LD 1007 that configures a part of the light-source device 11 form an image on the screen 15. The screen 15 serves as a divergent part that diverges the laser beams at a predetermined divergence angle. The screen 15 as illustrated in FIG. 6 has a microlens-array structure in which a plurality of hexagonal-shaped microlenses 150 are arranged with no gap therebetween. The lens diameter of each one of the microlenses 150 (the distance between two sides that are opposed to each other) is about 200 micrometers (m). As the microlenses 150 of the screen 15 have a hexagonal shape, the multiple microlenses 150 can be arrayed with high density. The microlens array 200 and the microlenses 150 according to the present embodiment will be described later in detail.

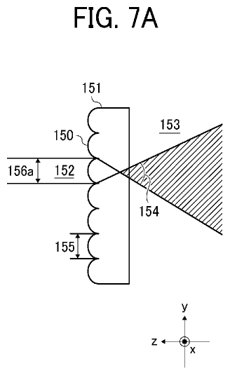

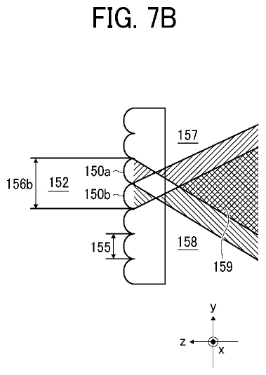

FIG. 7A and FIG. 7B are diagrams illustrating a difference in operation due to differences in sizes of the diameter of incident light flux and the lens diameter in the microlens array 200, according to the present embodiment. In FIG. 7A, the screen 15 is configured by an optical plate 151 in which the multiple microlenses 150 are neatly arranged. When an incident light 152 is scanned on the optical plate 151, the incident light 152 diverges as passing through the microlenses 150, and the incident light 152 becomes a diverging light 153. Due to the structure of the microlenses 150 of the screen 15, the incident light 152 can diverge at a desired divergence angle 154. The intervals 155 at which the microlenses 150 are arranged is designed to be wider than the diameter 156a of the incident light 152. Accordingly, the screen 15 does not cause interference among the lenses, and interfering noise can be prevented from occurring.

FIG. 7B is a diagram illustrating the optical paths of diverging lights when the diameter 156b of the incident light 152 is twice wider than the intervals 155 at which the microlenses 150 are arranged. The incident light 152 is incident on two microlenses 150a and 150b, and these two microlenses 150a and 150b produce two diverging lights 157 and 158, respectively. In such cases, lights may interfere with each other as two diverging lights exist in an area 159. Such an interference between two diverging lights (coherent light) is visually recognized as an interfering noise by an observer.

In view of the above circumstances, the intervals 155 at which the microlenses 150 are arranged is designed to be wider than the diameter 156 of the incident light 152 in order to reduce the interfering noise. A configuration with convex lenses are described as above with reference to FIG. 7A and FIG. 7B. However, no limitation is indicated thereby, and a similar situation is expected in a configuration with concave lenses.

Optical Scanning by Light Deflector

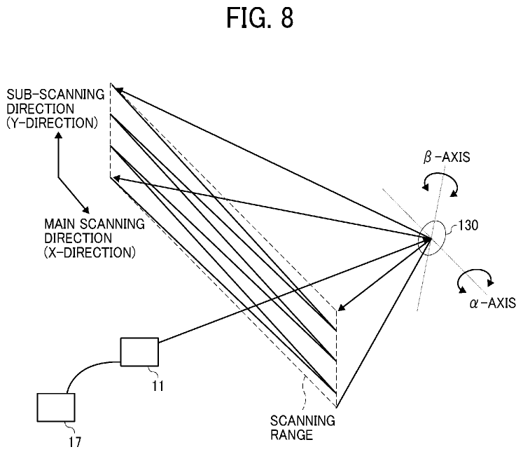

FIG. 8 is a diagram illustrating the relation between a minor of the light deflector 13 and the scanning range, according to the present embodiment. The FPGA 1001 controls the light-emission intensity, the timing of light emission, and the light waveform of the multiple light-source elements in the light-source device 11. The LD driver 1008 drives the multiple light-source elements of the light-source device 11 to emit laser beams. As illustrated in FIG. 8, the laser beams that are emitted from the multiple light-source elements and whose optical paths are combined are two-dimensionally deflected about the α axis and the β axis by the minor 130 of the light deflector 13, and the screen 15 is irradiated with the laser beams deflected by the mirror 130, which serve as scanning beams. In other words, the screen 15 is two-dimensionally scanned by main scanning and sub-scanning by the light deflector 13.

In the present embodiment, the entire area to be scanned by the light deflector 13 may be referred to as a scanning range. The scanning beams scan (two-way scans) the scanning range of the screen 15 in an oscillating manner in the main scanning direction (X-axis direction) at a high frequency of about 20,000 to 40,000 hertz (Hz), and one-way scan the scanning range of the screen 15 in the sub-scanning direction (Y-axis direction) at a low frequency of about a few tens of Hz. In other words, the light deflector 13 performs raster scanning on the screen 15. In this configuration, the display device 10 controls the light emission of the multiple light-source elements according to the scanning position (the position of the scanning beam). Accordingly, an image can be drawn on a pixel-by-pixel basis and a virtual image can be displayed.

As described above, the sub-scanning cycle is about a few tens of Hz. Accordingly, the length of time to draw an image of one frame, i.e., the length of time to scan one frame (one cycle of two-dimensional scanning) is a few tens of millisecond (msec). For example, assuming that the main-scanning cycle and the sub-scanning cycle are 20,000 Hz and 50 Hz, respectively, the length of time to scan one frame is 20 msec.

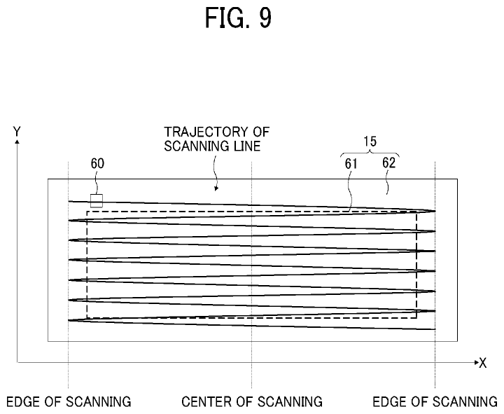

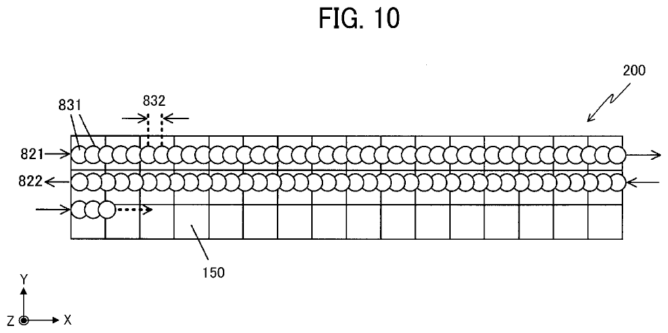

FIG. 9 is a diagram illustrating the trajectory of a scanning line when two-dimensional scanning is performed, according to the present embodiment. As illustrated in FIG. 9, the screen 15 includes an image area 61 (i.e., an effective scanning area) and a frame area 62 that surrounds the image area 61. The image area 61 is irradiated with the light that is modulated according to the image data, and the intermediate image 40 is drawn on the image area 61.

In the present embodiment, the scanning range includes the image area 61 and a part of the frame area 62 (i.e., a portion around the periphery of the image area 61) on the screen 15. In FIG. 9, the trajectory of the scanning line in the scanning range is indicated by a zigzag line. For the sake of explanatory convenience, the number of scanning lines in FIG. 9 is less than the actual number of scanning lines.

For example, the screen 15 may be configured by a transmissive optical element such as the microlens array 200 that diffuses light. In the present embodiment, the shape of the image area 61 is rectangular or planar. However, no limitation is intended thereby, and the shape of the image area 61 may be polygonal or curved. Further, in some embodiments, the screen 15 may be a reflective optical element such as a micromirror array that diffuses light, depending on the design or layout of the display device 10. In the following description of the present embodiment, it is assumed that the screen 15 is configured by the microlens array 200.

The screen 15 is provided with a synchronous detection system 60 that includes a light receiver disposed at the edges of the image area 61 (a part of the frame area 62) in the scanning range. In FIG. 9, the synchronous detection system 60 is disposed on the −X and +Y side of the image area 61. More specifically, the synchronous detection system 60 is disposed at a corner on the +Y side. The synchronous detection system 60 detects the operation of the light deflector 13 and outputs, to the FPGA 1001, a synchronizing signal that determines the start timing of scanning or the end timing of scanning.

Plotted Dots on Microlens Array

The plotted dots that are plotted on the microlens array 200 are described below with reference to FIG. 10. FIG. 10 is a diagram illustrating the plotted dots on the microlens array 200, according to the present embodiment. The plotted dots are dots that are plotted (formed) on the microlens array 200 by the laser beams (bundle of laser beams) emitted from the light-source elements 111 when the modulating signal is at a high level. In the display device 10, a pattern can be drawn with a higher resolution as the spacing among the centers of the plotted dots is smaller. The plotted dots are referred to also as beam spots.

When the surface of the microlens array 200 is scanned by a scanning beam, the control unit 175 of the image display unit 174 generates a modulating signal for each one of the light-source elements 111 (on a color-by-color basis), based on the image data sent from the image generator 173. Then, the control unit 175 outputs the generated modulating signal to the LD driver 1008, and modulates the light-emission intensity of the multiple light-source elements 111 at high speed. The light deflector 13 two-way scans the surface of the screen 15 in the main scanning direction (i.e., the X-axis direction), where reference signs 821 and 822 denote the first half of the go and return scanning and the second half of the go and return scanning, respectively.

In the display device 10, a pattern can be drawn on the microlens array 200 with a higher resolution as the modulation frequency (i.e., the frequency of a modulating signal) (such a modulation frequency will be referred to as a clock frequency in the following description) is higher. The minimum plotting width 832 (i.e., the spacing between the centers of a pair of dots 831 that are adjacent to each other), among a plurality of dots 831 that are drawn instantaneously, is determined by the relation between the clock frequency and the plotting speed (imaging speed) of a scanning line. Note also that the light-source elements 111 are turned on when the modulating signal is at a high level “1”, and are turned off when the modulating signal is at a low level “0”. Moreover, the intensity of a modulating signal for each one of the light-source elements 111 (on a color-by-color basis) is dependent on the ratio of each color (red, green, or blue) in the color information of image data for each one of the pixels.

In the following description, the gap among the lighting dots in the main scanning direction (i.e., the X-axis direction) is referred to as the pitches of lighting dots (reference sign 832 denotes such a gap in FIG. 10). The gap between two scanning lines in the sub-scanning direction (i.e., the gap between the first half 821 of the go and return scanning and the second half 822 of the go and return scanning, as illustrated in FIG. 10) is referred to as the pitch of two scanning lines.

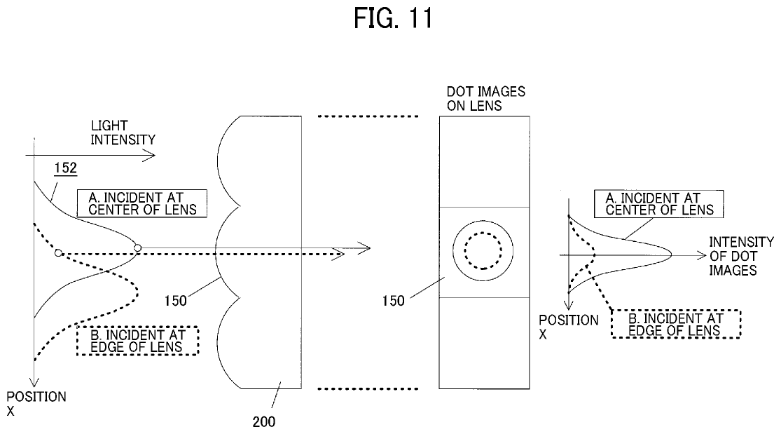

FIG. 11 is a diagram illustrating the relation between the incident position of light flux on one of the microlenses 150 and the intensity of dot images on that microlens 150, according to the present embodiment. In the present embodiment, the optical center of that microlens 150 matches the geometric center.

The incident light 152 that is incident on each of the microlenses 150 has an intensity profile of the Gaussian distribution specific to laser beams. In the incident light 152, the intensity is higher at the center of the light flux, and the intensity becomes lower as shifting away from the center of the light flux.

For purposes of illustration, it is assumed that the incident light 152 that is incident on one of the microlenses 150 is observed from the front side of that microlens 150. As indicated by “A.” in FIG. 11, when the incident light 152 of the beam intensity indicated by a solid line is incident on one of the microlenses 150, the center of that microlens 150 approximately matches the center of the incident light flux. Accordingly, the intensity of dot images on that microlens 150 increases.

By contrast, when the incident light 152 of the beam intensity indicated by a broken line is incident on one of the microlenses 150 as indicated by “B.” in FIG. 11, the center of that microlens 150 is significantly displaced from the center of the incident light flux. Accordingly, the intensity of the light flux that passes through the center of the microlens 150 corresponds to a tail of the Gaussian distribution, and the intensity of dot images on that microlens 150 decreases. In other words, the intensity of dot images on the microlens 150 in FIG. 11 is smaller for the case “B.” than the case “A.”

As described above, the intensity of dot images on the microlens 150 decreases as the displacement between the center of the light flux incident on microlens 150 and the center of that microlens 150 is greater. Due to this configuration, in the display device 10, the microlens array 200 is scanned such that an overlapping region of a plurality of plotted dots is placed at the center of each one of the microlenses 150. Due to this configuration, the intensity of dot images on the microlens 150 can be prevented from decreasing, and the variations in brightness can be reduced in the entirety of the microlens array 200.

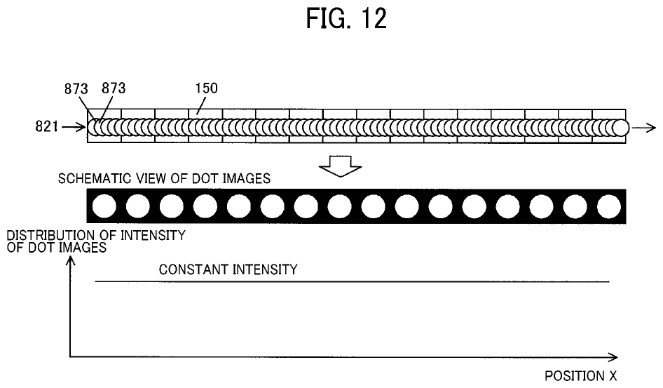

The distribution of the intensity of dot images when the surface of the microlens array 200 is two-dimensionally scanned using a scanning beam is described below with reference to FIG. 12. FIG. 12 is a diagram illustrating the distribution of the intensity of dot images on the microlens array 200 when the light-source device 11 is continuously turned on with a constant output, according to the present embodiment. In FIG. 12, the distribution of the intensity of dot images in the main scanning direction of the microlens array 200 (i.e., a lens array consisting of the multiple microlenses 150 arranged in the main scanning direction, which corresponds to the first half 821 of the go and return scanning) is illustrated.

Firstly, a case in which all the plotted dots are illuminated with the same intensity is described. When the spacing among the centers of the adjacent plotted dots 873 in a scanning line is sufficiently narrow (when the pitches of lighting dots are sufficiently narrow), the light flux passes through the microlenses 150 near the center of each one of the microlenses 150. More specifically, when the pitches of lighting dots are narrower than the lens pitch of the microlenses 150 in the main scanning direction, each of the multiple microlenses 150 forms at least one plotted dot. Due to this configuration, the variations in the brightness of the virtual image 45 can efficiently be controlled in the display device 10. Note also that the lens pitch indicates the spacing among the vertices of the multiple microlenses 150.

The distribution of the intensity of dot images when the light-source device 11 is repeatedly turned on to scan the microlens array 200, in an output pattern that includes at least one a high-power mode (for example, a mode in which the light-source device 11 emits light with the maximum power output) and at least one a low-power mode (for example, a mode in which the light-source device 11 emits light with power lower than the maximum power output), is described below. In the present embodiment, the high-power mode indicates a mode in which the light-source device 11 emits light with relatively high power output, and the low-power mode indicates a mode in which the light-source device 11 emits light with relatively low power output (lower than the high-power mode). The high-power mode may be a mode in which the light-source device 11 emits light with power output lower than the maximum power output.

When the light emitted from the three light-source elements 111 that correspond to the three colors of RGB is combined to generate desired colored light (the light corresponding to the color information of image data for each one of the pixels), the output levels of the light-source elements 111 of multiple colors need to be adjusted. For this reason, except when white colored light is to be generated, the output levels of the high-power mode and the low-power mode need to be differentiated among the light-source elements 111 according to the ratio of each color in the color information of image data for each one of the pixels.

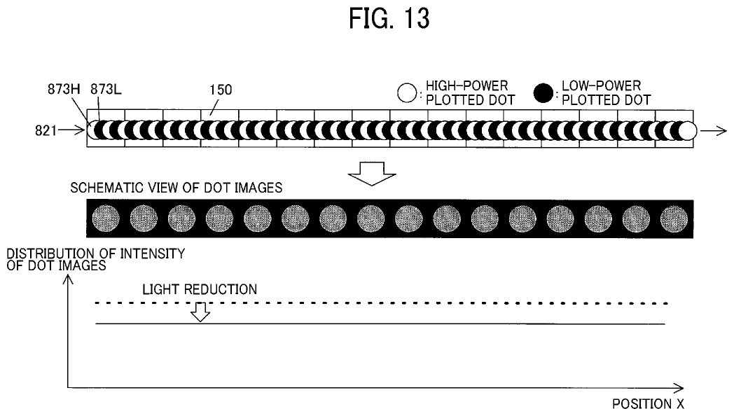

As an example of such an output pattern, FIG. 13 illustrates an example embodiment in which the multiple plotted dots 873 as illustrated in FIG. 12 are plotted alternately between the high-power mode and the low-power mode as the light-source device 11 is repeatedly turned on in an output pattern that includes one high-power mode and one low-power mode. The plotted dots that are plotted in a high-power mode (i.e., the white-colored plotted dots as illustrated in FIG. 13) are denoted by a reference sign 873H, and the plotted dots that are plotted in a low-power mode (i.e., the black-colored plotted dots as illustrated in FIG. 13) are denoted by a reference sign 873L. In the following description, the plotted dots that are plotted in a high-power mode are referred to as high-power plotted dots, and the plotted dots that are plotted in a low-power mode are referred to as low-power plotted dots. In FIG. 13, high-power plotted dots and low-power plotted dots partially overlap.

When the output pattern as illustrated in FIG. 13 is repeated, the light-source device 11 is turned on in the low-power mode at regular time intervals compared with a case in which all the plotted dots are plotted in a high-power mode. Due to this configuration, the display device 10 can reduce the total intensity of the light emitted to the microlens array 200 to reduce the brightness of the virtual image 45.

The scanning condition and the lens array are adjusted such that the pitch of the high-power plotted dots becomes smaller than the lens diameter of the microlens 150 in the main scanning direction. Due to this configuration, the multiple microlenses 150 can form at least one high-power plotted dot. Due to this configuration, in the display device 10, the variations in light intensity on the multiple microlenses 150 can be reduced, and the variations in brightness on the entire image can also be reduced.

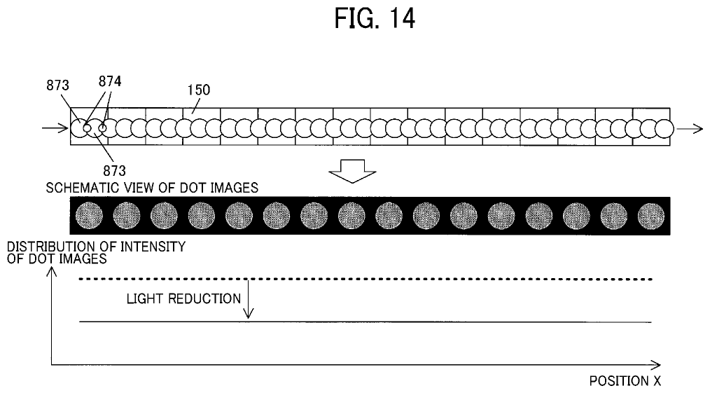

The distribution of the intensity of dot images on the microlens 150 when thinned-out lighting is performed is described below. The term “thinned-out lighting” indicates that the light-source device 11 is repeatedly turned on in an output pattern in which the low-power mode is replaced with a shutoff mode (i.e., a mode where the light source is turned off), i.e., an output pattern that includes at least one high-power mode (turned-on mode) and at least one shutoff mode. FIG. 14 illustrates an example embodiment in which the light-source device 11 is repeatedly turned on in an output pattern that includes one high-power mode and one shutoff mode. Each zero-power dot 874, which is illustrated in FIG. 14 as a small open circle, indicates the timing at which shutoff mode is performed.

The total number of plotted dots when plotting is performed in the output pattern as illustrated in FIG. 14 is half the total number of plotted dots when plotting is performed in the output pattern as illustrated in FIG. 13. For this reason, the brightness of the virtual image 45 in the output pattern as illustrated in FIG. 14 is reduced by one-half compared with the output pattern as illustrated in FIG. 13. As described above, in the display device 10, the fading rate (brightness reduction rate) can be increased as the shutoff mode is performed in place of the low-power mode.

When the pitches of lighting dots are sufficiently small in a shutoff mode (for example, when the lens diameter of the microlens 150 in the main scanning direction is wider than the pitches of lighting dots), the multiple microlenses 150 can form at least one plotted dot. Due to this configuration, changes in intensity of dot images, as illustrated in FIG. 11, are controlled. Accordingly, a loss (dropout) of pixel or the variations in brightness due to the thinned-out lighting can also be reduced in the display device 10.

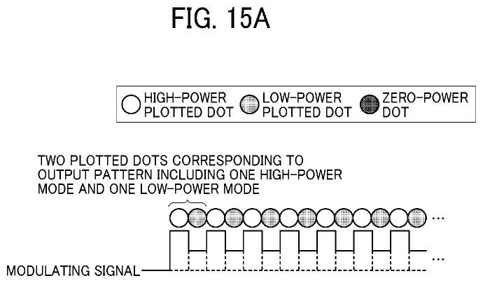

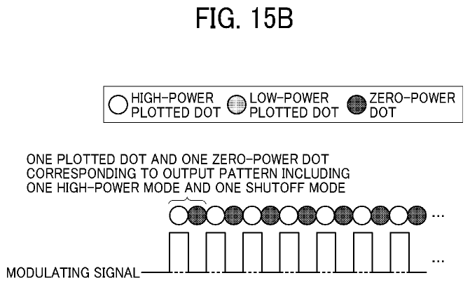

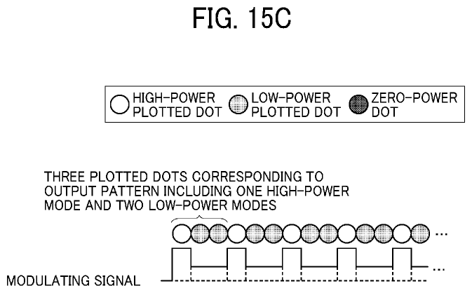

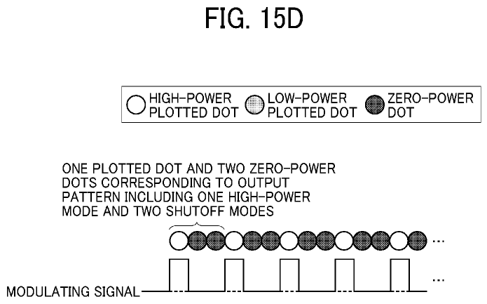

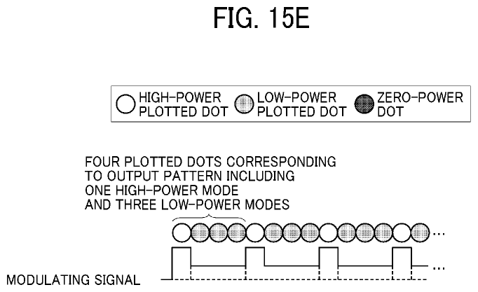

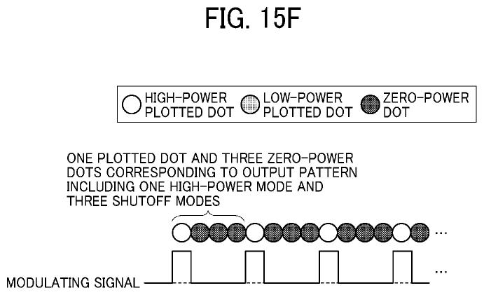

In the display device 10 according to the present embodiment, the ratio of the number of times the high-power mode is performed to the number of times the low-power mode (or the shutoff mode) is performed can be changed to vary the fading rate. By adopting this method for the display device 10, a plurality of output patterns where the fading rates are different from each other can be obtained. Here, concrete examples of a plurality of different output patterns where the fading rates are different from each other are described with reference to FIG. 15A to FIG. 15F. FIG. 15A to FIG. 15F are diagrams illustrating six arrays of plotted dots and six modulating signals, which correspond to six output patterns where the fading rates are different from each other, according to the present embodiment. In the description with reference to FIG. 15A to FIG. 15F, it is assumed that the output level in the high-power mode is the maximum power output and the output levels in the low-power mode are equal to each other among the multiple output patterns.

As illustrated in FIG. 15A, when high-power plotted dots and low-power plotted dots are arranged in alternating sequence, i.e., when the light-source device 11 is repeatedly turned on in an output pattern that includes one high-power mode and one low-power mode, the fading rate from the maximum brightness (i.e., the brightness achieved when the light source is continuously turned on with the maximum power output) is approximately 50% at maximum.

As illustrated in FIG. 15B, when high-power plotted dots and zero-power dots are arranged in alternating sequence, i.e., when the light-source device 11 is repeatedly turned on in an output pattern that includes one high-power mode and one shutoff mode, the fading rate from the maximum brightness is 50%.

As illustrated in FIG. 15C, when a pattern in which two continuous low-power plotted dots are arranged after one high-power plotted dot is arranged is repeated, i.e., when the light-source device 11 is repeatedly turned on in an output pattern that includes one high-power mode and two continuous low-power modes, the fading rate from the maximum brightness is approximately 66% at maximum.

As illustrated in FIG. 15D, when a pattern in which two continuous zero-power dots are arranged after one high-power plotted dot is arranged is repeated, i.e., when the light-source device 11 is repeatedly turned on in an output pattern that includes one high-power mode and two continuous shutoff modes, the fading rate from the maximum brightness is approximately 66%.

As illustrated in FIG. 15E, when a pattern in which three continuous low-power plotted dots are arranged after one high-power plotted dot is arranged is repeated, i.e., when the light-source device 11 is repeatedly turned on in an output pattern that includes one high-power mode and two continuous low-power modes, the fading rate from the maximum brightness is approximately 75% at maximum.

As illustrated in FIG. 15F, when a pattern in which three continuous zero-power dots are arranged after one high-power plotted dot is arranged is repeated, i.e., when the light-source device 11 is repeatedly turned on in an output pattern that includes one high-power mode and two continuous shutoff modes, the fading rate from the maximum brightness is 75%.

As described above, in the display device 10, the fading rate can be changed by adopting several combinations of the high-power mode and the low-power mode (or the shutoff mode) in an output pattern. In the display device 10, as the number of low-power plotted dots or zero-power dots is greater, the fading rate can be increased to a greater value. The variations in brightness are more likely to occur as the number of low-power plotted dots or zero-power dots increases. However, in any of the possible cases, as long as the spacing among the high-power plotted dots is equal to or narrower than the lens diameter of the microlenses, variations in brightness can be prevented from occurring in the display device 10.

Neighboring plotted dots and zero-power dots are illustrated in FIG. 15A to FIG. 15F as if the neighboring plotted dots do not overlap with each other and the zero-power dots do not overlap with the neighboring plotted dots. However, in actuality, it is desired that the neighboring plotted overlap with each other and the zero-power dots overlap with the neighboring plotted dots. In FIG. 15A to FIG. 15F, an output pattern composed of one high-power mode and one low-power mode (or one shutoff mode) or two or three continuous low-power modes (or two or three continuous shutoff modes) is illustrated by way of example. However, the display device 10 may adopt an output pattern that includes one high-power mode and four or more continuous low-power modes (or four or more continuous shutoff modes).

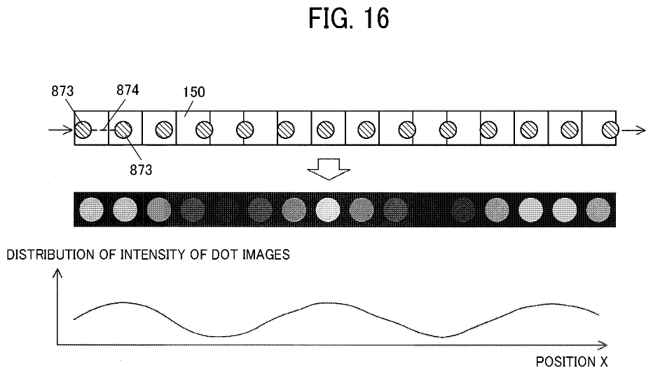

Next, moire that is caused by the intervals at which thinning-out is performed and the intervals at which lenses are arranged (i.e., the lens pitch of the microlenses in the main scanning direction) is described with reference to FIG. 16. FIG. 16 is a diagram illustrating the relation among the intervals at which thinning-out is performed, the intervals at which lenses are arranged, and the moire, according to the present embodiment. For example, the intervals at which thinning-out is performed indicate the intervals at which turning-on is performed (i.e., the intervals at which a turned-on mode is performed) when thinned-out lighting is performed, the intervals at which shutoff is performed (i.e., the intervals at which a shutoff mode is performed) when thinned-out lighting is performed, the pitches of lighting dots when thinned-out lighting is performed, or the pitches of zero-power dots (i.e., the spacing among the centers of zero-power dots) when thinned-out lighting is performed.

In FIG. 16, when the width of the dark region 874 (i.e., the zero-power dot) between a pair of neighboring plotted dots 873 gets wider, the variations in brightness are more likely to occur on a display image. As known in the art, it is not possible to match the intervals at which thinning-out is performed to the intervals at which lenses are arranged, with a high degree of precision. As illustrated in FIG. 16, the zero-power dots and the lenses are arranged at different intervals. In such a configuration, the relative positions of the center of the lens and the plotted dot change in a continuous manner in each of the lenses. As a result, the intervals at which thinning-out is performed and the intervals at which lenses are arranged cause a spatial beat, and as illustrated in a lower part of FIG. 16, the brightness of dot images tends to be visually recognized as a long-period pattern in the main scanning direction. This phenomenon is called moire (interference fringes) that is caused by the intervals at which thinning-out is performed and the intervals at which lenses are arranged.

Even if the width of the original intervals at which thinning-out is performed is about one lens, the intervals are expanded to a long-period pattern over the width of several lenses to several tens of lenses. Accordingly, moire (interference fringes) is very much easily recognized by the eyes of the viewer 3, and the viewability of the image deteriorates. As described above, due to this configuration, in order to control the moire, the display device 10 turns on the light-source device 11 on such that at least one plotted dot is formed by the multiple microlenses 150.

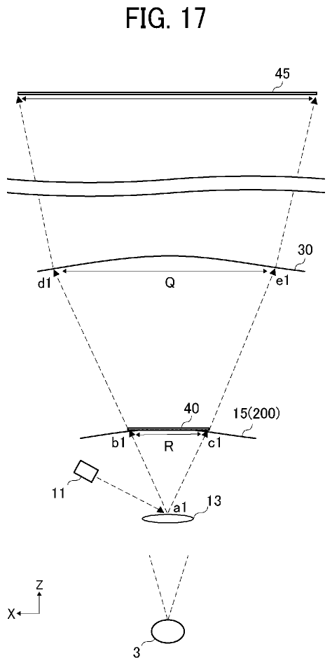

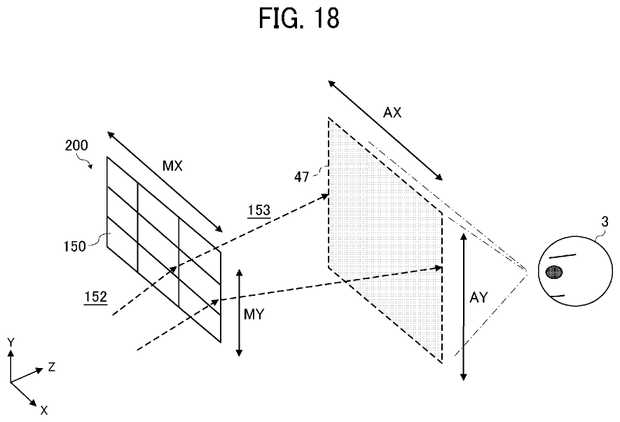

A configuration of the display device 10 according to the present embodiment is described below in detail with reference to FIG. 17 to FIG. 25F. Firstly, the relation between the microlenses 150 and an eye box 47 are described with reference to FIG. 17 to FIG. 21.

FIG. 17 is a schematic diagram illustrating the relative positions of the elements in the display system 1, according to the present embodiment. For the sake of explanatory convenience, it is assumed in FIG. 17 that the elements of the system are arranged in parallel on the XZ plane. However, no limitation is indicated thereby, and in actuality, it is not necessary for the elements of the system to be arranged parallel to the XZ plane as illustrated in FIG. 1.

The bundles of laser beams generated by the light-source device 11 are incident on the point al of the light deflector 13, and are two-dimensionally scanned on the screen 15 as deflected by the light deflector 13. The screen 15 forms the intermediate image 40 with a width R in the X-axis direction (main scanning direction).

When the intermediate image 40 at an edge in the +X-direction is to be formed, the bundles of laser beams emitted from the light-source device 11 are deflected by the light deflector 13 in the +X-direction, and a portion of the intermediate image 40 is drawn at a point b 1. When the intermediate image 40 at an edge in the −X-direction is to be formed, the bundles of laser beams emitted from the light-source device 11 are deflected by the light deflector 13 in the −X-direction, and a portion of the intermediate image 40 is drawn at a point c1. The image that is drawn on the screen 15 is configured by the image generator 173 of the controller 17.

The screen 15 is configured by the microlens array 200. The bundles of laser beams that scan the screen 15 diverge at a predetermined divergence angle as passing through the microlens array 200. In FIG. 17, each of the laser beams that are emitted from the microlens array 200 indicates the central light beam of the diverging light. The bundles of laser beams that are emitted from the microlens array 200 are incident on the freeform surface mirror 30. Q denotes the band pass of the bundles of laser beams on the free-form surface mirror 30.

When an image at an edge in the +X-direction is to be formed in such a configuration as above, the central light beam of the diverging light is incident on a point dl of the free-form surface mirror 30. When an image at an edge in the −X-direction is to be formed, the central light beam of the diverging light is incident on a point e1 of the free-form surface mirror 30.

The plane of the free-form surface mirror 30 is designed and shaped so as to reduce the optical strain that occurs on the front windshield 50. The bundles of laser beams that have passed through the free-form surface mirror 30 are then incident on the front windshield 50, and reach at least one point of the location of the eyepoint within an eyelips area including the reference eyepoint of the viewer 3. The bundles of laser beams that are incident on the front windshield 50 are reflected according to the shape of the surface of the front windshield 50.

For example, in the display system 1 as illustrated in FIG. 1, the viewer 3 (for example, the driver who drives a car) visually recognizes the virtual image 45 in an eye box (i.e., an area near the eyes of the viewer 3) in the optical path of the light that is reflected by the front windshield 50. Here, the term “eye box” indicates the area in which the viewer 3 can visually recognize the virtual image 45 without adjusting the location of the eyepoint. In particular, the range of the eye box 47 is equal to or less than “the eye range of a car driver” (Japanese Industrial Standards (JIS) D 0021). The eye box 47 is set as the area through which the driver can visually recognize the virtual image 45, based on the eyelips that is a region of space in which the eyepoint of the driver seated on a seat can exist.

The relation between the microlens array 200 that configures the screen 15 and an eye box is described below with reference to FIG. 18. FIG. 18 is a diagram illustrating the relation between the microlens array 200 and the eye box 47, according to the present embodiment. For the sake of explanatory convenience, the elements that are arranged in the optical path after the microlens array 200 are omitted in FIG. 18, and the space between the microlens array 200 and the viewer 3 is linearly expressed.

As illustrated in FIG. 8, the microlens array 200 as illustrated in FIG. 18 includes the multiple microlenses 150 that are arrayed in a two-dimensional region. The incident light 152 that contains the image data is incident on the multiple microlenses 150 that make up the microlens array 200. Accordingly, the viewer 3 can visually recognize a display image that includes prescribed items of information, on a region (i.e., the eye box 47) where the diverging light 153 that diverges as passing through each of the microlenses 150 can visually be recognized.

The eye box 47 is is determined by the diverging light 153 that diverges as passing through the microlens 150. Due to this configuration, the X-axis direction and the Y-axis direction of each of the microlenses 150 on a two-dimensional region (XY region) matches the X-axis direction and the Y-axis direction of the eye box 47. The aspect ratio (MX/MY) of the X-axis direction (horizontal direction) to the Y-axis direction (vertical direction) of each of the microlenses 150 is equal to the aspect ratio (AX/AY) of the X-axis direction (horizontal direction) to the Y-axis direction (vertical direction) of the eye box 47.

In the present embodiment, the Y-axis direction (i.e., the vertical direction) of the eye box 47 is perpendicular to the line of sight of the viewer 3 such as the driver of a car. On the other hand, the X-axis direction (i.e., the horizontal direction) of the eye box 47 is in a horizontal direction perpendicular to a direction orthogonal to the line of sight of the viewer 3.

Further, when the radius of curvature of the microlens 150 is constant in both the X-axis direction and the Y-axis direction, the shape of the diverging light 153 from one of the microlenses 150, i.e., the shape of the eye box 47 corresponds to the shape of the corresponding microlens 150. In other words, the shape of the microlenses 150 is to be designed according to a desired shape of the eye box 47 (visually-recognizable area).

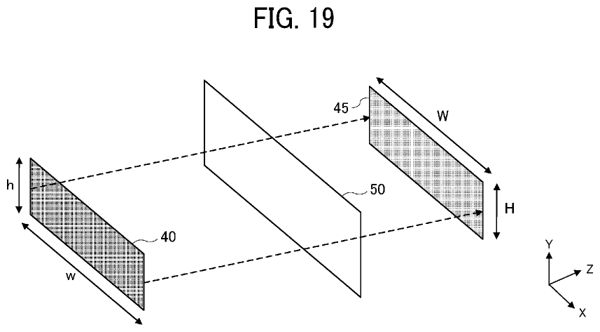

FIG. 19 is a diagram illustrating the relation between the intermediate image 40 and the virtual image 45, according to the present embodiment. The intermediate image 40 is formed as the laser beams emitted from the light deflector 13 scan the surface of the screen 15. The virtual image 45 is an image that the viewer 3 can visually identify as the projection light projected from the display device 10 is reflected by the front windshield 50.

The intermediate image 40 that is formed on the screen 15 is magnified and projected towards the front windshield 50. In other words, the shape of the intermediate image 40 is similar to the shape of the virtual image 45. For example, in the case as illustrated in FIG. 19, the width W and the height H of the virtual image 45 is a magnified image of the width w and the height h of the intermediate image 40.

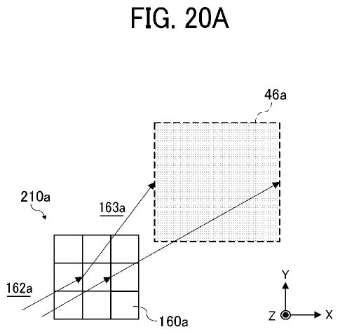

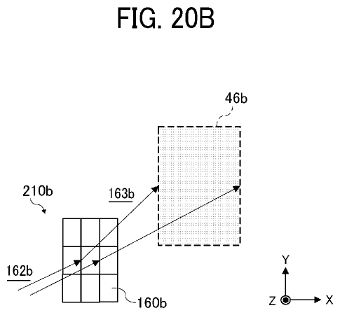

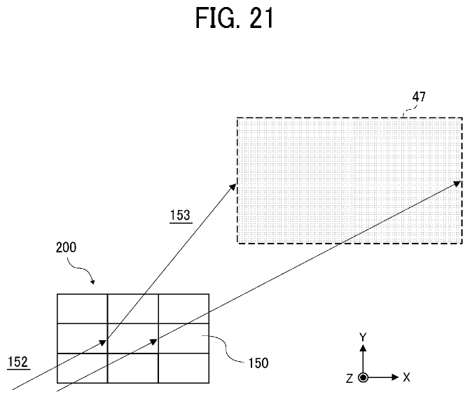

The relation between the shape of microlenses and the shape of an eye box is described below with reference to FIG. 20A, FIG. 20B. and FIG. 21. In the following description, it is assumed that the radius of curvature of the microlens 150 is constant in both the X-axis direction and the Y-axis direction. FIG. 20A and FIG. 20B are schematic diagrams each illustrating the relation between the shape of microlenses and the shape of an eye box, according to a control sample.

FIG. 20A is a diagram illustrating how the incident light 152 incident on the microlenses 160a each of which is in a square shape in a planar view diverges as passing through the microlenses 160a and an eye box 46a is formed by the diverging light 153. As described above with reference to FIG. 18, the eye box 46a is square-shaped as the shape of the eye box 46a matches the shape of the microlens 160a.

FIG. 20B the incident light 152 incident on the microlenses 160b each of which is a vertically-elongated rectangle in a planar view diverges as passing through the microlenses 160b and is a diagram illustrating how an eye box 46b is formed by the diverging light 153. In a similar manner to FIG. 20A, the shape of the eye box 46b in FIG. 20B is a vertically oriented rectangle as the shape of the eye box 46a matches the shape of the microlens 160b.

For example, when the display system 1 as illustrated in FIG. 1 is used as a mobile object such as a car, the X-axis direction indicates the horizontal direction and the Y-axis direction indicates the vertical direction when viewed from the driver's seat. In this configuration, the display device 10 displays, for example, a navigation image ahead of the front windshield 50 as the virtual image 45. Accordingly, the viewer 3 who is the driver can observe such a navigation image without moving his/her line of vision away from the ahead of the front windshield 50 while staying in the driver's seat. In such a configuration, the front windshield 50 is horizontally oriented, and thus it is desired that the virtual image 45 be horizontally oriented when viewed from the driver. In other words, preferably, each of the intermediate image 40 formed on the microlenses and the virtual image 45 has a larger angle of view in the X-axis direction.

It is also desired that the viewing angle be wider in the horizontal direction (X-axis direction) than in the vertical direction (Y-axis direction) such that the driver (i.e., the viewer 3) can recognize the displayed image even in a slanting direction from the right and left sides. For this reason, a greater divergence angle (anisotropic diffusion) is required for the X-axis direction (i.e., the horizontal direction) of the virtual image 45 compared with the divergence angle (anisotropic diffusion) in the Y-axis direction (vertical direction). In other words, in the display device 10, the range in the X-axis direction (i.e., the horizontal direction) of the eye box 47 needs to be configured wider than the range in the Y-axis direction (vertical direction).

However, the length in the X-axis direction (i.e., the horizontal direction) of the eye boxes 46a and 46b according to the control sample as illustrated in FIG. 20A and FIG. 20B is equal to or shorter than the length in the Y-axis direction (i.e., the vertical direction) of the eye boxes 46a and 46b. Due to this configuration, the brightness of the image that is to be visually recognized by the viewer 3 deteriorates as the visually-recognizable area in the vertical direction needs to be expanded to secure the visually-recognizable area in the horizontal direction where the viewpoint of the driver (i.e., the viewer 3) can easily be moved.

In order to handle such a situation, the display device 10 according to the present embodiment the microlens array 200 is arranged such that the major (longer) axis direction of the microlenses 150 matches the major (longer) axis direction of the eye box 47. FIG. 21 is a diagram illustrating the relation between the shape of the microlenses 150 and the shape of the eye box 47, according to the present embodiment. The microlenses 150 according to the present embodiment are in a horizontally-oriented shape that corresponds to the shape of the horizontally-oriented eye box 47. As illustrated in FIG. 21, each of the microlenses 150 has a horizontally-oriented rectangular shape in which the sides in the X-axis direction (horizontal direction) are long and the sides in the Y-axis direction (vertical direction) are short. As the microlenses 150 of such a shape as above is adopted in the display device 10, the range in the X-axis direction of the eye box 47 that is formed by the diverging light 153 that diverges as passing through the microlens 150 can be made wider than the range in the Y-axis direction to achieve a horizontally-oriented shape.

In the present embodiment, the X-axis direction (i.e., the horizontal direction) of the microlens 150 and the eye box 47 is in the major (longer) axis direction, and the Y-axis direction (i.e., the vertical direction) is in the minor (shorter) axis direction. The major (longer) axis direction of the eye box 47 is a direction orthogonal to the line of sight of the viewer 3. On the other hand, the minor (shorter) axis direction of the eye box 47 is in a horizontal direction perpendicular to a direction orthogonal to the line of sight of the viewer 3. The major (longer) axis direction of the microlenses 150 is the direction in which the diverging light 153 is emitted, which correspond to the range in the major (longer) axis direction of the eye box 47.

When the major (longer) axis direction of the microlenses 150 matches the major (longer) axis direction of the eye box 47 as described above, those two major (longer) axis direction (axial direction) are not necessarily parallel with each other in a strict sense. Instead, a predetermined level of utilization efficiency of light is maintained, and the range or shape of the diverging light 153 that diverges as passing through of the microlenses 150 is matched with the range or shape of the eye box 47. In other words, there may be a predetermined level of displacements in angle ranging from several degrees to several tens of degrees between the major (longer) axis direction of the microlenses 150 and the major (longer) axis of the eye box 47.

As described above, in the display device 10, the light diverges to a minimum area that satisfies the desired angle of view to improve the utilization efficiency of light. Due to this configuration, the brightness of the image that is to be visually recognized by the viewer 3 improves. The microlenses 150 are an example of a plurality of microlenses, and the microlens array 200 is an example of an optical element.

Arrangement of Microlenses

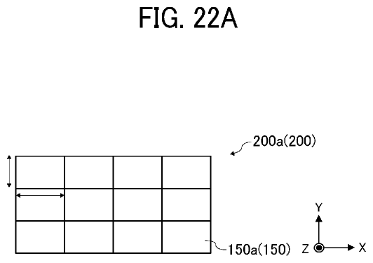

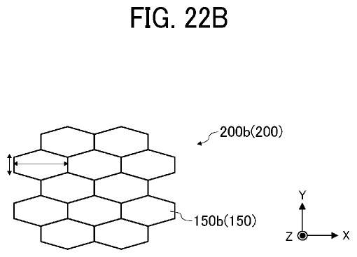

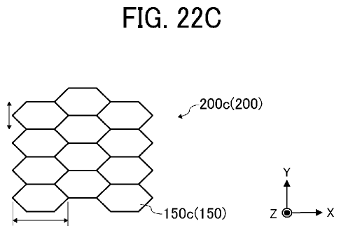

The lens array of the microlens array 200 are described below with reference to FIG. 22A to FIG. 22C. FIG. 22A to FIG. 22C are diagrams each illustrating the arrangement of microlenses in a microlens array according to the present embodiment.

As illustrated in FIG. 21, the microlens array 200 as illustrated in FIG. 22A to FIG. 22C is configured by the arrayed multiple microlenses 150 where the length in the X-axis direction (horizontal direction) is longer than the length in the Y-axis direction (vertical direction). in the display device 10, the microlens array 200 as illustrated in FIG. 22A to FIG. 22C is used to form the horizontally-oriented eye box 47.

In FIG. 21, the microlens array 200a as illustrated in FIG. 22A in which the horizontally-oriented rectangular microlens 150a are arranged in a planar view is described by way of example. However, no limitation is indicated thereby, and a similar configuration may be applied to other kinds of microlens array with different lens patterns or lens arrays. For example, the configurations according to the present embodiment may be applied to the microlens arrays 200b and 200c as illustrated in FIG. 22B and FIG. 22C where the hexagonal microlens 150b and 150c, which are horizontally-oriented in a planar view, are arranged, respectively.

In the microlens array 200b as illustrated in FIG. 22B, a horizontally-oriented hexagonal microlens 150b are densely arranged. The microlenses 150b do not have any side parallel to the X-axis direction (i.e., the horizontal direction). In other words, the upper sides and lower sides of the microlenses 150b arranged in the X-axis direction (horizontal direction) draw zigzag lines. The arrangement of the microlens array 200b is referred to as a zigzag-type array.

In the microlens array 200c as illustrated in FIG. 22C, a horizontally-oriented hexagonal microlens 152c are densely arranged. The microlens 150c as illustrated in FIG. 22C has a side parallel to the X-axis direction (i.e., the horizontal direction). The arrangement of the microlens array 200c is referred to as an armchair-type array. Moreover, the zigzag-type array and the armchair-type array may collectively be referred to as a honeycomb-type array.

When the lens pitch of the microlenses is shortened in the present embodiment, the resolution of the image increases. Due to this configuration, preferably, the microlens array 200b or 200c in honeycomb arrangement, as illustrated in FIG. 22B or FIG. 22C, is used in the display device 10.

As illustrated in FIG. 13 and some other drawings, preferably, the length of the microlens 150 in the X-axis direction (i.e., the horizontal direction) is shorter than the pitches of lighting dots of the high-power plotted dots. In other words, the distance between each pair of the neighboring high-power plotted dots is shorter than the length of the microlenses 150 in the major (longer) axis direction. Due to this configuration, at least one high-power plotted dot can be formed by the multiple microlenses 150. Accordingly, in the display device 10, the variations in light intensity can be reduced on each one of the multiple microlenses 150, and the variations in brightness on the entire image can also be reduced.

Further, when the length of lights-out time (i.e., the width of a zero-power dot) is to be increased in order to increase the fading rate, the lens diameter of the microlens 150 in the main scanning direction needs to be lengthened. The resolution of the image that is to be visually recognized by the viewer 3 depends on the total number of lenses of the microlens 150, and the resolution increases as the total number of microlenses is larger. Due to this configuration, in addition to the configuration in which the intensity of the light emitted from the light source is changed while the multiple microlenses 150 are being scanned, it is desired that the lens diameter in the sub-scanning direction be shorter than the lens diameter in the main scanning direction.

As illustrated in FIG. 22A to FIG. 22C, in the microlens array 200 with the multiple microlenses 150 in which the lens diameter in the main scanning direction is wider than the lens diameter in the sub-scanning direction, the intensity of the light that is emitted from the light source can easily be changed while the multiple microlenses 150 are being scanned. In other words, at least one high-power plotted dot and at least one low-power plotted dot (or zero-power dots) can easily be formed on the multiple microlenses 150. Accordingly, in the display device 10, the fading rate can be increased while preventing the variations in brightness and the reduction in resolution from occurring.

In the display device 10, it is desired that the microlens array 200 be arranged such that the main scanning direction of the light deflector 13 is matched with the major (longer) axis direction of the microlenses 150 in order to improve the utilization efficiency of light in the horizontally-oriented eye box 47. Moreover, as described above, preferably, the pitch of the two scanning lines in the sub-scanning direction is shorter than both the lens diameter of the microlens 150 in the Y-axis direction (i.e., the minor (shorter) axis direction) and the beam diameter in the sub-scanning direction. Due to this configuration, in the display device 10, moire on the image that is to be visually recognized by the viewer 3 can be reduced to improve the image quality.

Further, it is desired that the microlens array 200b in armchair arrangement as illustrated in FIG. 22B be used in the display device 10 in order to enhance the effect of decreasing moire. Theoretically, when the direction of the scanning line is close to the direction in which the vertices of lenses are arranged, the shape of moire significantly changes due to a slight variation between the scanning line and the direction of the lens array. This is because, for example, the shape of moire changes from the center to periphery of the image and the viewability of the image deteriorates when the shape of the scanning line changes on the surface of the image. When the moire caused by the direction of the scanning line and the direction of the lens array is taken in consideration, in the microlens 150c of zigzag type as illustrated in FIG. 22C, the direction of the scanning line and the vertices of lenses matches the direction of the lens array in which the vertices of lenses are connected. Due to this configuration, the cycle of moire significantly changes due to a slight angular variation between the direction of the scanning line and the direction of the lens array, and moire easily occurs. By contrast, the direction of the scanning line does not match the direction of the lens array in the armchair-type microlenses 150b as illustrated in FIG. 22B. In this configuration, the shape of moire does not significantly change even if an angular variation is caused between the direction of the scanning line and the direction of the lens array, and moire does not occur.

Eccentricity

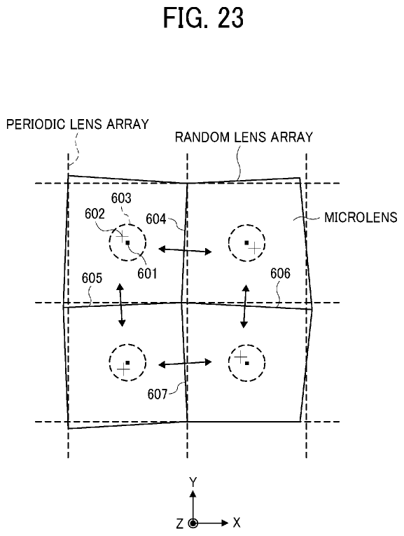

The lens pitch of the microlenses 150 and the randomization of the directions of the boundaries of lenses are described below with reference to FIG. 23 to FIG. 25F. Firstly, the fact that the microlens array 200 according to the present embodiment is different from known diffuser panels used to reduce the number of speckle patterns is described. As known in the art, a large number of bumps and dips with varying sizes are formed on the surface of a diffusing board. For example, when there are bumps and dips whose sizes are very much smaller than the beam spot diameter (i.e., the diameter of incident light flux), the interference between the reflected laser beams increases at such bumps and dips, and moire tends to occur. In order to handle such a situation, in the present embodiment, a random lens array where the lens diameter of each lens is equal to or greater than a prescribed value on its entirety is suggested.

FIG. 23 is a diagram illustrating the vertices of a plurality of microlenses in a random lens array, according to the present embodiment. For example, a random lens array has structure based on a periodic lens array in which a plurality of square-shaped lenses indicated in FIG. 23 by broken lines in a grid pattern are arranged with a constant lens pitch. A periodic lens array is a microlens array in which the pitch (lens pitch) of the vertices of a plurality of microlenses, i.e., the spacing between the vertices of two microlenses that are adjacent to each other, is periodic (for example, constant).

In such periodic lens arrays, the center of each microlens is a grid point 601 (virtual point) of each tetragonal lattice. Moreover, in such periodic lens arrays, the vertex of each microlens is supposed to match the grid point 601 that is the center of each microlens. In order to prevent interference of light diverging from two microlenses that are adjacent to each other (such diverging light may be referred to as contiguous diverging light or the like), the lens diameter of each microlens of such periodic lens arrays is set greater than the beam spot diameter (i.e., the diameter of incident light flux). In other words, the lens diameter is set to a lens diameter equal to or greater than the above prescribed value.

A random lens array has a structure in which the vertex of each microlens of a periodic lens array is displaced (decentered) from the center within the virtual region 603 that includes the center (i.e., the grid point 601) of the microlens. In other words, a vertex 602 of each microlens in a random lens array is decentered. Further, the vertex 602 of each microlens in a random lens array is displaced from the grid point 601 at which the microlens is arranged.

By contrast, a plurality of microlenses of a periodic lens array are individually arranged on a plurality of grid points where the lens pitch is constant, and the vertex of each microlens matches the grid point at which the microlens is arranged. For example, the center of each microlens in a random lens array may be the center of the circumscribed circle (circumcircle) of the microlens, or may be the center of the inscribed circle (incircle) of the microlens.

A random lens array is a microlens array in which the lens pitch is randomized. A random lens array has a structure in which the optical axis (Z-axis) of each microlens of a periodic lens array, where the vertex 602 of each microlens matches the center of the microlens, is randomly shifted (offset) in an direction perpendicular to the optical axis (X-axis direction, Y-axis direction). In other words, the lens pitch has an irregular structure in a random lens array. In such a configuration, the light incident on the microlenses of the random lens array passes through the vertex 602 of each microlens, but does not pass through the center.

Moreover, in a random lens array, the displacement of the vertex of each one of the multiple microlenses from the center of the microlens is irregular, and thus the lens pitch is irregular. In other words, the microlenses are adjacent to each other in the scanning direction of the light deflector 13 in the random lens array according to the present embodiment, and the line segments that connect the vertices of the microlenses are not parallel to each other.

Further, the directions of the boundaries of lenses of a random lens array (i.e., the directions of multiple solid lines 604, 605, 606, and 607 as illustrated in FIG. 23) are randomly (irregularly) displaced from the directions of the boundaries of lenses of a periodic lens array (i.e., the direction of the multiple grid lines (broken lines) as illustrated in FIG. 14). In such a configuration, the directions in which moire occurs in the multiple microlenses are different from each other. As a result, macroscopically, the directions of moire are not in line with each other, and thus the visibility of the interfering noise decreases. When a random lens array is not adopted, a highly coherent beam that are incident on two or more neighboring lenses is visually recognized as an interfering noise with regular cycles by an observer. When a microlens array is replaced with a random lens array, interfering noise with regular cycles that is caused by a beam that is incident on two or more neighboring lenses can be randomized, and the degree of interference is dispersed. Accordingly, the visibility of the image improves.

In view of the above-described characteristics, the microlens array 200 according to the present embodiment is configured by a random lens array. Although the vertices of the lenses slightly shift in the microlens array 200, the lens diameter is approximately kept constant. Accordingly, the incident light can be prevented from sticking out from the lenses, and the interference caused by the light diverging from two of the microlenses 150 that are adjacent to each other can be reduced.

The lens pitch is randomized in the microlens array 200, and the microlenses are adjacent to each other in the scanning direction of the light deflector 13. Moreover, the line segments that connect the vertices of the microlenses are not parallel to each other. Due to this configuration, the degree of interference is reduced, and interfering noise can be prevented from occurring. Further, as the directions of the boundaries of lenses are randomized in the microlens array 200, the directions of the occurring interfering noise are randomized. Due to this configuration, the visibility of the interfering noise can significantly be reduced. Accordingly, in the display device 10, the visibility of the image (optical image) that is configured by a random lens array can be improved.

In the present embodiment, thee laser beams emitted from the light-source device 11 the effective sectional area of is not circular but is elliptic. Due to this configuration, as illustrated in FIG. 7A and FIG. 7B, when it is determined that the beam diameter of incident light is smaller than the lens diameter of each one of the microlenses 150, it is desired that the aspect ratio (for example, horizontally-oriented aspect ratio) be selected according to the shape (elliptical shape) of the effective sectional area of the laser beams. Due to this configuration, the interfering noise can be prevented from occurring with the minimum necessary lens diameter in the microlens array 200 that includes the horizontally-oriented microlenses 150. Note that the effective sectional area indicates a portion of the cross-sectional area of the laser beams where the relative strength is between 20% and 80%.

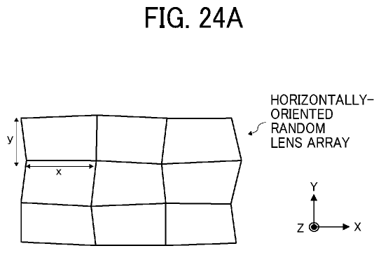

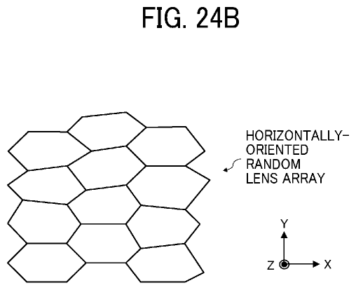

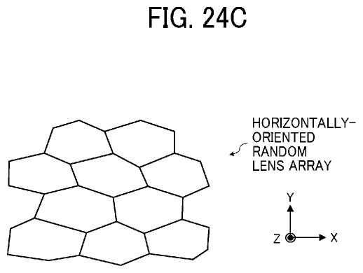

FIG. 24A to FIG. 24C are diagrams each illustrating a concrete example of a random lens array that includes a plurality of horizontally-oriented microlenses (such a random lens array may be referred to as a horizontally-oriented random lens array in the following description), according to the present embodiment. In the following description, the microlens array 200 according to the present embodiment that includes the horizontally-oriented microlenses 150 will be referred to as a horizontally-oriented random lens array. The horizontally-oriented random lens array as illustrated in FIG. 24A has structure based on a periodic lens array, in which a plurality of rectangular microlenses are arranged in a matrix. Each one of the microlens of such a periodic lens array has a horizontally oriented aspect ratio, and the relation “x>y” holds true.

The horizontally-oriented random lens array as illustrated in FIG. 24B has structure based on a periodic lens array, in which a plurality of horizontally-oriented hexagonal microlenses are arranged in a zigzag-type array. The horizontally-oriented random lens array as illustrated in FIG. 24C has structure based on a periodic lens array, in which a plurality of horizontally-oriented hexagonal microlenses are arranged in an armchair-type array. In the horizontally-oriented random lens arrays as illustrated in FIG. 24A to FIG. 24C, the lens pitches and the directions of the boundaries of lenses are randomized, and thus the interfering noise with regular pitches can be prevented from occurring.

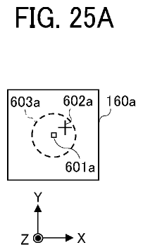

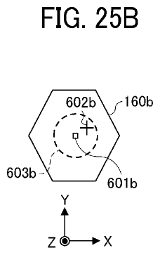

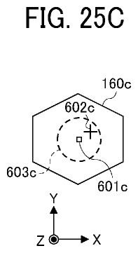

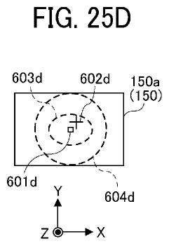

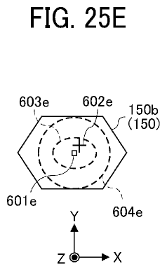

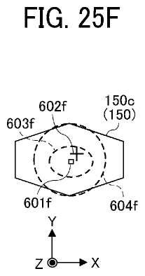

FIG. 25A to FIG. 25C are diagrams each illustrating the vertex of a microlens according to a control sample. In these drawings, broken lines indicate a virtual boundary, and each white-colored small square indicates the center of each microlens. Moreover, a sign “+” indicates the vertex of each microlens.

The vertex 602a of a horizontally-oriented rectangular microlens 160a, as illustrated in FIG. 25A, is set to a random point that is selected with equal probability inside a circular virtual boundary 603a that is drawn with equal distance from the center 601a of the microlens 160a. In other words, the vertex 602a of the microlens 160a is randomly decentered inside the virtual boundary 603a. In such a configuration, the vertex 602a of the microlens 160a is decentralized while the maximum value for the amount of displacement from the center 601a is determined. In the following description, the area within a virtual boundary (virtual region) is referred to as a decentering region.

However, the fact that the microlens 160a as illustrated in FIG. 25A is horizontally oriented is not taken into consideration. There is high probability that the relative amount of random decentering in the Y-axis direction (i.e., the vertical direction) with reference to the length of the microlens in the Y-axis direction (vertical direction) (such a relative amount of random decentering is referred to as a random eccentricity ratio in the vertical direction in the following description) is greater than the amount of random decentering in the X-direction (horizontal direction) (such a relative amount of random decentering is referred to as a random eccentricity ratio in the horizontal direction in the following description) with reference to the length of the microlens in the X-direction (horizontal direction). In such a configuration, the effects of random decentering may vary between the Y-direction (vertical direction) and the X-direction (horizontal direction).

In this configuration, the effect of reduction in interfering noise increases as the random eccentricity ratio is higher. However, when the random eccentricity ratio is high, compressions and rarefactions occur on the lens-array surface, and structural stripes or granularity tend to increase. As a result, the images may appear grainy. For this reason, preferably, the random eccentricity ratio in the Y-direction (vertical direction) and the X-direction (horizontal direction) is appropriately controlled to control the granularity. For example, when the amount of random decentering in the Y-direction (vertical direction) is equal to the amount of random decentering in the X-direction (horizontal direction), the random eccentricity ratio in the X-direction (horizontal direction) becomes higher than the random eccentricity ratio in the Y-direction (vertical direction).

In FIG. 25A, the horizontally-oriented rectangular microlens 160a is illustrated by way of example. However, for example, a similar configuration may be applied to the horizontally-oriented hexagonal microlens 160b and 160c illustrated in FIG. 25B and FIG. 25C, respectively.

FIG. 25D to FIG. 25F are diagrams each illustrating the vertex of a horizontally-oriented microlens, according to the present embodiment. Horizontally-oriented microlenses 150a, 150b, and 150c, as illustrated in FIG. 25D, FIG. 25E, and FIG. 25F, respectively, are provided with horizontally-oriented virtual boundaries 603d, 603e, and 603f, respectively, where each of these horizontally-oriented virtual boundaries serves as a horizontally-oriented decentering region. In such configurations, the amount of random decentering in the Y-axis direction (vertical direction) and the X-axis direction (horizontal direction) can be controlled in an independent manner.

In the horizontally-oriented random lens arrays, the vertex of each one of the microlenses 150 within a horizontally-oriented decentering region is selected with equal probability (randomly decentered). Accordingly, the sum of the amounts of decentering (i.e., the amounts of displacement from the center) in the X-axis direction at the vertices of the multiple microlenses 150 included in the horizontally-oriented random lens array is greater than the sum of the amounts of decentering (i.e., the amounts of displacement from the center) in the Y-axis direction at the vertices of the multiple microlenses 150. In other words, in the horizontally-oriented random lens arrays, the vertex 602 (602d, 602e, and 6030 of each one of the multiple microlenses 150 are displaced from the grid points 601 (601d, 601e, 6010, and the direction in which the sum of the amounts of displacement of the vertex 602 (602d, 602e, and 6030 from the grid points 601 (601d, 601e, 6010 is large is the major (longer) axis direction of the microlenses 150.

In the arrangement described above, the term “sum” may be replaced with “average.” Such an average may be an “arithmetic mean” or “geometric mean.” In other words, in the horizontally-oriented random lens arrays, the number of microlenses when the amount of decentering in the X-axis direction at the vertex is greater than the amount of decentering in the Y-axis direction is greater than the number of microlenses (including zero) when the amount of decentering in the Y-axis direction at the vertex is greater than the amount of decentering in the X-axis direction.

In the horizontally-oriented random lens arrays, it is desired that the maximum value for the amount of decentering in the X-axis direction be less than half the value for the length of each one of the microlenses 150 in the X-axis direction, and it is desired that the maximum value for the amount of decentering in the Y-axis direction be less than half the value for the length of each one of the microlenses 150 in the X-axis direction.

Further, it is desired that the length of a horizontally-oriented decentering region in the X-axis direction (horizontal direction) be set to, for example, a value equal to or less than four-fifth of the length of each one of the microlenses 150 in the X-axis direction, and it is desired that the length of a horizontally-oriented decentering region in the Y-axis direction (vertical direction) be set to, for example, a value equal to or less than four-fifth of the length of each one of the microlenses 150 in the Y-axis direction. This is because the granularity tends to increase when the horizontally-oriented decentering region expands to an excessive degree with reference to the microlens 150.

The dimension of a horizontally-oriented decentering region may be set according to the curvature of the microlens 150 (i.e., the divergence angle). More specifically, the dimension of a horizontally-oriented decentering region may be increased as the curvature (divergence angle) of the microlenses 150 is greater.

Further, preferably, a horizontally-oriented decentering region does not stick out from each of the microlenses 150. In other words, it is desired that the length of the horizontally-oriented decentering region in the X-axis direction be less than the length of each one of the microlenses 150 in the X-axis direction, and it is desired that the length of the horizontally-oriented decentering region in the Y-axis direction be less than the length of that microlens 150 in the Y-axis direction.

Moreover, it is desired that the dimension of a horizontally-oriented decentering region be equal to or smaller than the dimension of a regular polygon circumscribing a circle (see 604d, 604e, and 604f in FIG. 25D, FIG. 25E, and FIG. 25F, respectively) whose diameter is equal to the maximum length of the lengths of the horizontally-oriented microlenses 150 in the Y-axis direction, where the number of sides of such a regular polygon is n (where n denotes an integer equal to or greater than 3). In other words, it is desired that the dimension of a horizontally-oriented decentering region be equal to or smaller than the dimension of the decentering region of the maximum regular polygon that can be set to the horizontally-oriented microlenses 150, where the number of sides of that regular polygon is n (where n denotes an integer equal to or greater than 3). The above regular polygon may be, for example, a square and a regular hexagon. In such a configuration, the amount of random decentering in the vertical direction of the dimension of a horizontally-oriented decentering region can efficiently be controlled compared with the decentering region of a regular polygon whose dimension is equal to that of the horizontally-oriented decentering region, where the number of sides of that regular polygon is n (where n denotes an integer equal to or greater than 3), and thus the granularity can be prevented from increasing.

Further, it is desired that the dimension of a horizontally-oriented decentering region be equal to or smaller than the dimension of a circle whose diameter is equal to the maximum length of the lengths of the horizontally-oriented microlenses 150 in the Y-axis direction. In other words, it is desired that the dimension of a horizontally-oriented decentering region be equal to or smaller than the dimension of the maximum circular decentering region that can be set to a horizontally-oriented microlens. In such a configuration, the amount of random decentering in the Y-axis direction (vertical direction) can efficiently be controlled compared with a circular decentering region whose dimension is equal to that of the horizontally-oriented decentering region, and thus the granularity can be prevented from increasing. In such a configuration, the dimension of a horizontally-oriented decentering region is equal to or smaller than the dimension of the decentering region of the maximum regular polygon that can be set to the horizontally-oriented microlenses 150, where the number of sides of that regular polygon is n (where n denotes an integer equal to or greater than 3).

In order to adjust the random eccentricity ratio in the X-axis direction (horizontal direction) and the Y-axis direction (vertical direction) to have an appropriate value, preferably, the aspect ratio of a horizontally-oriented decentering region is set based on the aspect ratio of the microlenses 150. In other words, preferably, the ratio (lx/ly) of the length lx of the horizontally-oriented decentering region in the X-axis direction to the length ly of the horizontally-oriented decentering region in the Y-axis direction is set based on the ratio (Lx/Ly) of the length Lx of the microlenses 150 in the X-axis direction to the length Ly of the microlenses 150 in the Y-axis direction. More specifically, lx/ly is set so as to be equal to Lx/Ly. Alternatively, lx/ly may be set to be slightly greater than Lx/Ly, or may be set to be slightly less than Lx/Ly. In such a configuration, the amount of random decentering in the Y-axis direction can be controlled more than the amount of random decentering in the X-axis direction, and the granularity or roughness of the surface when the surface of the microlens array 200 is visually recognized can efficiently be controlled.

For example, the shape of a virtual boundary (decentering region) may be a horizontally-oriented elliptic shape, as illustrated in FIG. 25D, FIG. 25E, and FIG. 25F. However, as long as the shape of a virtual boundary (decentering region) is horizontally oriented, similar advantageous effects can be achieved. For example, the shape of a virtual boundary (decentering region) may be a horizontally-oriented rectangular shape. In any of the possible cases, the amount of random decentering or the degree of interference can be adjusted according to the degree of interference between diverging beams that are adjacent to each other. Alternatively, the probability distribution within a vertically-oriented decentering region may be changed or differentiated. For example, the distribution density of vertices may locally be increased or decreased within a vertically-oriented decentering region.

Method of Manufacturing Microlenses

A method of manufacturing a microlens array according to the present embodiment is described below. As known in the art, the micro-lens array is manufactured by producing a mold having a transfer surface of a lens surface array of the micro-lens array and transferring a mold surface to a resin material by using the mold. The transfer surface of the mold may be formed using, for example, cutting or photolithography processes. In addition, the transferring of the transfer surface to the resin material can be performed, for example, by injection molding. As described above, for example, the microlenses according to the present embodiment may be injection-molded with a resin material, using a mold having a transfer surface for the lens surface of a horizontally-oriented microlens.

The reduction of the radius of curvature of the boundary portion between the adjacent micro-lenses can be implemented by reducing the boundary width. The small boundary width can be implemented by “sharpening” the boundary portion formed between the adjacent micro-lens surfaces.

In the mold for micro-lens array, as a method of reducing the size of the “boundary width between the adjacent micro-lenses” down to the order of wavelength, a method of increasing the radius of curvature of each micro-lens by anisotropic etching and ion processing to remove non-lens portions of the boundary portion, and a method of removing a flat surface between adjacent micro-lenses by using isotropic dry etching are known in the art. For example, by using the above-described well-known methods, it is possible to manufacture a micro-lens array where the radius of curvature of the surface constituting the boundary portion between the adjacent micro-lenses is sufficiently small. In other words, the above-described to-be-scanned surface can be configured as a micro-lens array having a structure where a plurality of micro-lenses are arranged to be in close contact with each other.

By forming the micro-lens array where the radius of curvature r of the surface constituting the boundary portion between the adjacent micro-lenses is smaller than 640 nm, the coherent noise due to the R component beam can be prevented. In addition, by forming the micro-lens array where the radius of curvature r is smaller than 510 nm, the coherent noise due to the R component beam and the G component beam can be prevented. By forming the micro-lens array where the radius of curvature r of the surface constituting the boundary portion between the adjacent micro-lenses is smaller than 445 nm, the coherent noise due to the R, G, and B component beams can be prevented.

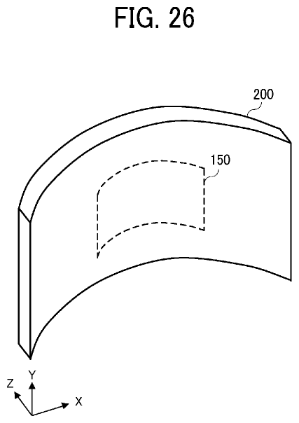

As illustrated in FIG. 26, the microlens array 200 may be curved in the entire array structure. In such a configuration, preferably, the direction of curvature (X-axis direction) of the microlens array 200 is matched with the major (longer) axis direction (X-axis direction) of the microlenses 150. Due to this configuration, in the display device 10, the divergence angle of the diverging light 153 that diverges as passing through the microlenses 150 can be adjusted to a desired angle of view without being affected by the size of the microlens array 200, and the utilization efficiency of light can be improved.

As the lens-array surface of the microlens array 200 is curved, the difference in optical path length between the optical scanning element (i.e., a MEMS mirror) and lens-array surface can be Kept constant in the display device 10. As the beam diameter formed on the lens-array surface is determined by the optical path length, the beam diameter can be kept constant in the display device 10 when the lens-array surface is curved. Further, as interfering noise is caused as a beam sticks out from the lens, the beam diameter can be kept constant in the display device 10. As a result, the interfering noise can be reduced, and high resolution is achieved.

As described above, the display device 10 according to an embodiment of the present disclosure includes the microlens array 200 (an example of an optical element) including the multiple microlenses 150 arranged in an array, through which the light diverges, and a light deflector 13 (an example of a scanner) that scans the microlens array 200 two-dimensionally using the light emitted from the light-source device 11 (an example of a light source). Moreover, the major (longer) axis direction of the eye box 47 (an example of a visually-recognizable area), where the virtual image 45 that is formed by the diverging light that diverges as passing through the microlens 150 can visually be recognized as a prescribed image, matches the major (longer) axis direction of the microlenses 150. Due to this configuration, in the display device 10, the shape of the diverging light 153 (i.e., the shape of the corresponding microlens 150) is matched to the shape of the eye box 47. Accordingly, the brightness of the image that is to be visually recognized by the viewer 3 can be prevented from decreasing.

In the display device 10 according to an embodiment of the present disclosure, the microlens array 200 (an example of an optical element) is two-dimensionally scanned by main scanning and sub-scanning by the light deflector 13 (an example of a scanner), and the scanning direction of main scanning is matched with the major (longer) axis direction of the microlenses 150 (an example of a plurality of microlenses). Due to this configuration, in the display device 10, the major (longer) axis direction of the microlenses 150 matches the main scanning direction of the light deflector 13, and the extinction ratio in the image that is to be visually recognized by the viewer 3 can be improved.

Moreover, in the display device 10 according to an embodiment of the present disclosure, the pitches of the scanning lines in the scanning direction of the sub-scanning performed by the light deflector 13 (an example of a scanner) is shorter than the lens diameter of the major (longer) axis direction of the microlenses 150 (an example of a plurality of microlenses), and is narrower than the beam diameter of the light scanned by the light deflector 13 in the sub-scanning direction. Due to this configuration, in the display device 10, moire in the image that is to be visually recognized by the viewer 3 can be reduced to improve the image quality.

In the display device 10 according to an embodiment of the present disclosure, the microlens array 200 (an example of an optical element) has a shape curved in a prescribed direction, and the direction of curvature of the microlens array 200 matches the major (longer) axis direction of the microlenses 150 (an example of a plurality of microlenses). Due to this configuration, in the display device 10, the divergence angle of the diverging light that diverges as passing through the microlenses 150 can further be increased without being affected by the size of the microlens array 200, and thus the utilization efficiency of light can be improved.

Moreover, in the display device 10 according to an embodiment of the present disclosure, the line segments that connect the vertices of the microlenses 150 that are adjacent to each other in the scanning direction of the light deflector 13 (an example of a scanner) are not parallel to each other in the microlens array 200 (an example of an optical element). Due to this configuration, in the display device 10, the vertices of the multiple microlenses 150 are randomly arranged, and thus cyclic interfering noise and moire can be reduced to improve the image quality.

In the display device 10 according to an embodiment of the present disclosure, in the microlens array 200 (an example of an optical element) the vertex 602 of each one of the multiple microlenses 150 is displaced from the grid point 601 (an example of a regular virtual point). Further, the direction in which the sum of the amounts of displacement of the vertices 602 from the grid points 601 is large is the major (longer) axis direction of the microlenses 150. Due to this configuration, in the display device 10, the brightness of the image that is to be visually recognized by the viewer 3 can be prevented from decreasing, and the image quality can also be improved.

Moreover, in the display device 10 according to an embodiment of the present disclosure, the distance between each pair of the neighboring high-power plotted dots, which is formed by the light beams that are emitted from the light-source device 11 (an example of a light source) with high output power, is shorter than the length of the major (longer) axis direction of the microlenses 150 (an example of a plurality of microlenses). Due to this configuration, in the display device 10, the brightness of the image that is to be visually recognized by the viewer 3 can be prevented from decreasing, and the fading rate can be enhanced.

In the display device 10 according to an embodiment of the present disclosure, the microlenses 150 (an example of a plurality of microlenses) are in a hexagonal shape, and the multiple microlenses 150 of the microlens array 200 (an example of an optical element) are arrayed in a honeycomb shape. Due to this configuration, in the display device 10, cyclic interfering noise or moire can be reduced by shortening the lens pitch of the microlenses 150, and the image quality of the image that is to be visually recognized by the viewer 3 can be improved.

Moreover, in the display device 10 according to an embodiment of the present disclosure, the microlenses 150 (an example of a plurality of microlenses) are in a hexagonal shape, and the multiple microlenses 150 of the microlens array 200 (an example of an optical element) are arrayed in a shape of armchair. Due to this configuration, in the display device 10, the direction of the scanning line does not match the direction of the lens array in which the multiple microlenses 150 are arranged. Due to this configuration, significant changes in moire on the surface of the image can be reduced, and the image quality of the image that is to be visually recognized by the viewer 3 can be improved.

The display system 1 according to an embodiment of the present disclosure includes the display device 10, the front windshield 50 (an example of a reflector) that reflects the diverging light 153 diverging from the microlens array 200 (an example of an optical element), and the free-form surface mirror 30 (an example of an imaging optical system) that projects the diverging light diverging 153 from the microlens array 200 towards the front windshield 50 to form the virtual image 45. Accordingly, in the display system 1, the brightness of the image that is to be visually recognized by the viewer 3 can be prevented from decreasing.

Numerous additional modifications and variations are possible in light of the above teachings. It is therefore to be understood that within the scope of the appended claims, the disclosure of the present disclosure may be practiced otherwise than as specifically described herein. For example, elements and/or features of different illustrative embodiments may be combined with each other and/or substituted for each other within the scope of this disclosure and appended claims.

The display device according to an embodiment of the present disclosure is applicable not only to a heads-up display (HUD) but also to, for example, a head-mounted display, a prompter, and a projector. For example, when a display device according to an embodiment of the present disclosure is applied to a projection device, such a projection device can be configured in a similar manner to the display device 10. In other words, the display device 10 may project the image light onto, for example, a projection screen or a wall through the free-form surface minor 30. Alternatively, the display device 10 may project the image light that has passed through the screen 15 onto, for example, a projection screen or a wall, without involving the freeform surface mirror 30.

The present disclosure can be implemented in any convenient form, for example using dedicated hardware, or a mixture of dedicated hardware and software. The present disclosure may be implemented as computer software implemented by one or more networked processing apparatuses. The processing apparatuses can compromise any suitably programmed apparatuses such as a general purpose computer, personal digital assistant, mobile telephone (such as a WAP or 3G-compliant phone) and so on. Since the present disclosure can be implemented as software, each and every aspect of the present disclosure thus encompasses computer software implementable on a programmable device. The computer software can be provided to the programmable device using any conventional carrier medium (carrier means). The carrier medium can compromise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

This patent application is based on and claims priority pursuant to 35 U.S.C. § 119(a) to Japanese Patent Application No. 2018-050972, filed on Mar. 19, 2018, in the Japan Patent Office, the entire disclosure of which is hereby incorporated by reference herein.

### REFERENCE SINGS LIST

1 Display system
10 Display device
11 Light-source device (an example of a light source)
13 Light deflector (an example of a scanner)
15 Screen
30 Free-form surface mirror
45 Virtual image
47 Eye box (an example of a visually-recognizable area)
50 Front windshield (an example of a reflector)
150 Microlens
200 Microlens array (an example of an optical element)

1. A display device comprising:
an optical element including a plurality of microlenses arranged in an array, through which light diverges; and
a scanner configured to scan the optical element two-dimensionally using light emitted from a light source,
wherein a longer axis direction of a visually-recognizable area, where a virtual image formed by diverging light that diverges as passing through the plurality of microlenses can visually be recognized as a prescribed image, matches a longer axis direction of the plurality of microlenses.

2. The display device according to claim 1,
wherein the optical element is two-dimensionally scanned by main scanning and sub-scanning by the scanner, and
wherein a scanning direction of the main scanning matches the longer axis direction of the plurality of microlenses.

3. The display device according to claim 2,
wherein a pitch of two scanning lines in the sub-scanning direction is shorter than a lens diameter in the longer axis direction of the plurality of microlenses and is narrower than a beam diameter of light scanned by the scanner in the sub-scanning direction.

4. The display device according to claim 1,
wherein the optical element has a shape curved in a prescribed direction, and
wherein a direction of curvature of the optical element matches the longer axis direction of the plurality of microlenses.

5. The display device according to claim 1,
wherein the plurality of microlenses are adjacent to each other in the optical element, and line segments that connect a plurality of vertices of the plurality of microlenses are not parallel to each other.

6. The display device according to claim 5,
wherein, in the optical element, each one of the plurality of vertices of the plurality of microlenses is displaced from a regular virtual point, and
wherein a direction in which a sum of amounts of displacement of each one of the plurality of vertices from the regular virtual point is large is equivalent to the longer axis direction of the plurality of microlenses.

7. The display device according to claim 1,
wherein a distance between each pair of neighboring high-power plotted dots formed by light emitted from the light source with high output power is shorter than a length in the longer axis direction of the plurality of microlenses.

8. The display device according to claim 1,
wherein the plurality of microlenses are in a hexagonal shape,
wherein, in the optical element, the plurality of microlenses are arrayed in a honeycomb shape.

9. The display device according to claim 8, wherein the plurality of microlenses of the optical element are arranged in a shape of an armchair.

10. The display device according to claim 1, wherein the optical element is a microlens array in which the plurality of microlenses are arranged in an array.

11. A display system, comprising:
the display device according to claim 1;
a reflector configured to reflect light from the optical element; and
an imaging optical system configured to project the light from the optical element towards the reflector to form the virtual image.

12. A mobile object comprising:
the display system according to claim 11,
wherein the reflector is a front windshield of the mobile object.
